(19) United States
(12) Patent Application Publication
(10) Pub. No.: US 2026/0342932 A1
(43) Pub. Date: Oct. 29, 2026

(54) IMAGE PROCESSING DEVICE

(71) Applicant: KYOCERA Corporation, Kyoto (JP)

(72) Inventors: Kai SHIMIZU, Yokohama-shi, Kanagawa (JP); Hiroshi OKA, Kyoto-shi, Kyoto (JP); Masatoshi GO, Kagoshima-shi, Kagoshima (JP)

(21) Appl. No.: 19/124,292

(22) PCT Filed: Oct. 26, 2022
(86) PCT No.: PCT/JP2022/039861

§ 371 Date: Apr. 25, 2025

(51) Int. Cl. H04N 1/44; H04N 1/00

(52) U.S. Cl. CPC H04N 1/4433; H04N 1/00413; H04N 1/00474; H04N 1/4413; H04N 2201/0094

(57) ABSTRACT

In an image processing device, an operation panel is configured to accept an instruction from a user regarding image processing and be capable of displaying multiple history buttons containing information on past image processing. A storage unit is configured to be capable of storing image data and processing information indicating processing modes of image processing displayed on the history buttons. A controller is configured to, based on a result of login authentication, allow an authenticated user to access a specific type of image data and processing information via the history buttons and deny an unauthenticated user access to the specific type of image data via the history buttons and allow the unauthenticated user to access the processing information via the history buttons.

### RELATED APPLICATIONS

The present application is a National Phase of International Application Number PCT/JP2022/039861, filed Oct. 26, 2022.

### TECHNICAL FIELD

The present invention relates to an image processing device. Image processing is, for example, printing of images, scanning of images, or communication relating to images.

### BACKGROUND OF INVENTION

A known image processing device can display image processing history (for example, see Patent Literature 1 listed below). For example, the image processing device of Patent Literature 1 displays multiple buttons relating to image processing history on a touch panel. The buttons are arranged in order of the date and time when image processing was performed. Each button displays the type of image processing (copying, scanning, and so on), the image processing conditions (number of copies, color printing, double-sided printing, and so on), and the date and time the image processing was executed. When any one of the buttons is selected, the image processing conditions corresponding to that button are set as the conditions for the image processing that will be performed. This allows conditions that have been employed in the past to be easily reused.

### CITATION LIST

### Patent Literature

Patent Literature 1: Japanese Unexamined Patent Application Publication No. 2018-125687

### SUMMARY

In an aspect of the present disclosure, an image processing device includes an operation panel, a storage unit, and a controller. The operation panel is configured to accept an instruction from a user regarding image processing and be capable of displaying multiple history buttons containing information on past image processing. The storage unit is configured to be capable of storing image data and processing information indicating processing modes of image processing displayed on the history buttons. Based on a result of login authentication, the controller is configured to allow an authenticated user to access a specific type of image data and the processing information via the history buttons and deny an unauthenticated user access to the specific type of image data via the history buttons while allowing the unauthenticated user to access the processing information via the history buttons.

### BRIEF DESCRIPTION OF THE DRAWINGS

FIG. 1 is a block diagram illustrating an example of the configuration of an image processing device according to an embodiment.

FIG. 2 is a diagram illustrating an example of a login screen displayed on an operation panel of the image processing device in FIG. 1.

FIG. 3 is a diagram illustrating an example of a home screen transitioned to from the login screen in FIG. 2.

FIG. 4 is a diagram illustrating an example of a history use screen transitioned to from the home screen in FIG. 3.

FIG. 5 is a diagram illustrating another example of a history use screen.

FIG. 6 is a diagram illustrating an example of an image selection screen transitioned to from the history use screen in FIG. 5.

FIG. 7 is a diagram illustrating an example of permission and denial of access to data in the form of a table.

FIG. 8 is a schematic diagram for describing data that is automatically saved following image processing.

FIG. 9 is a schematic diagram for explaining a method for accessing data.

FIG. 10 is a schematic diagram illustrating examples of permission and denial of access to data.

FIG. 11 is a schematic diagram illustrating a display example of history buttons for when a user has been authenticated.

FIG. 12 is a schematic diagram illustrating a display example of history buttons for when a user has not been authenticated.

FIG. 13 is a schematic diagram illustrating another display example as an alternative to the display example in FIG. 11.

FIG. 14 is a schematic diagram illustrating an example of the configuration of data related to authentication stored in a storage unit of the image processing device in FIG. 1.

FIG. 15 is a schematic diagram illustrating an example of the configuration of data related to use of history stored in a storage unit of the image processing device in FIG. 1.

FIG. 16 is a schematic diagram illustrating an example of content held by processing information contained in the data in FIG. 15.

FIG. 17 is a flowchart illustrating an example of the procedure of authentication processing performed by the image processing device in FIG. 1.

FIG. 18 is a flowchart illustrating an example of the procedure of main processing performed by the image processing device in FIG. 1.

FIG. 19 is a flowchart connected to the flowchart illustrated in FIG. 18.

### DESCRIPTION OF EMBODIMENTS

### Overview of Image Processing Device

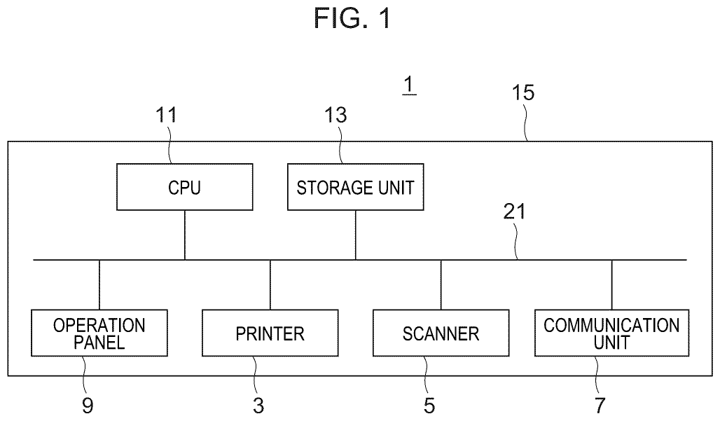

FIG. 1 is a block diagram illustrating the configuration of an image processing device 1 according to an embodiment.

The image processing device 1 is configured as a multifunction machine and includes, for example, the following sections. A printer 3 that performs printing. A scanner 5 that scans images. A communication unit 7 that communicates with the outside. An operation panel 9 that accepts operations from a user. A CPU 11 (central processing unit) that performs various operations. A storage unit 13 that stores various information.

The operation panel 9 includes a touch panel. The operation panel 9 may include operation targets other than the touch panel such as physical buttons. However in the description of the embodiments, for convenience, the description may be made with the assumption that the operation panel 9 includes only a touch panel.

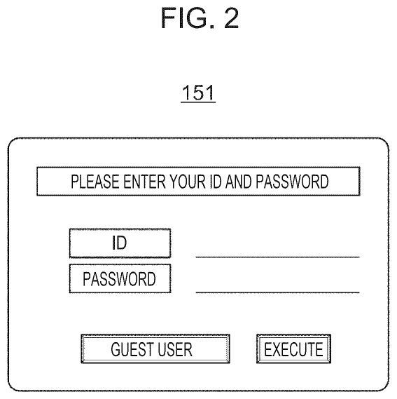

FIG. 2 is a diagram illustrating an example of a login screen 151 displayed on the operation panel 9.

As can be understood from the login screen 151, a user can log into the image processing device 1 as an authenticated user by inputting an ID (identification) and a password and tapping an “execute” button. In addition, the image processing device 1 can be used by an unauthenticated user by tapping a “guest user” button.

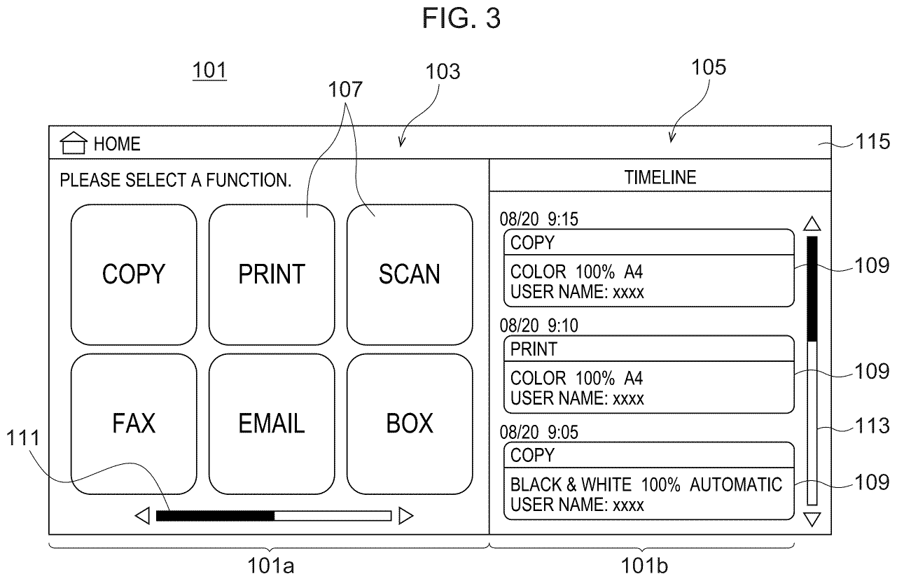

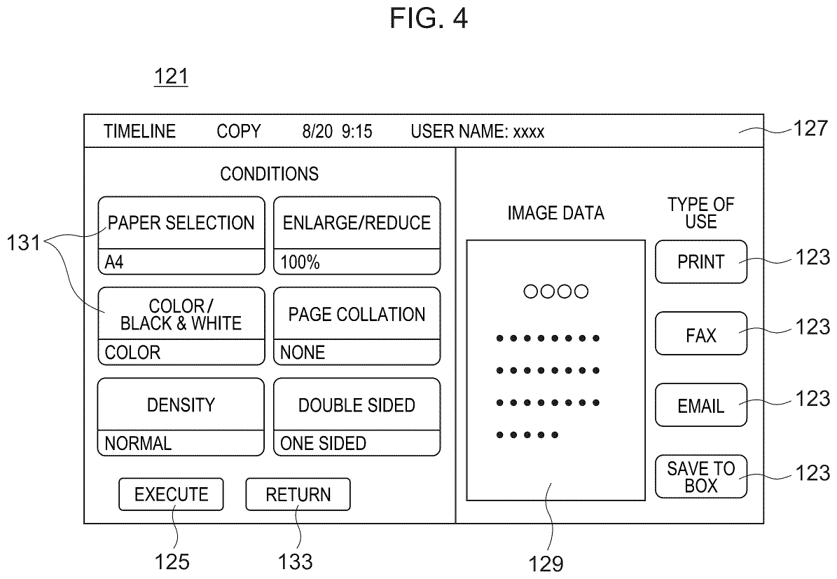

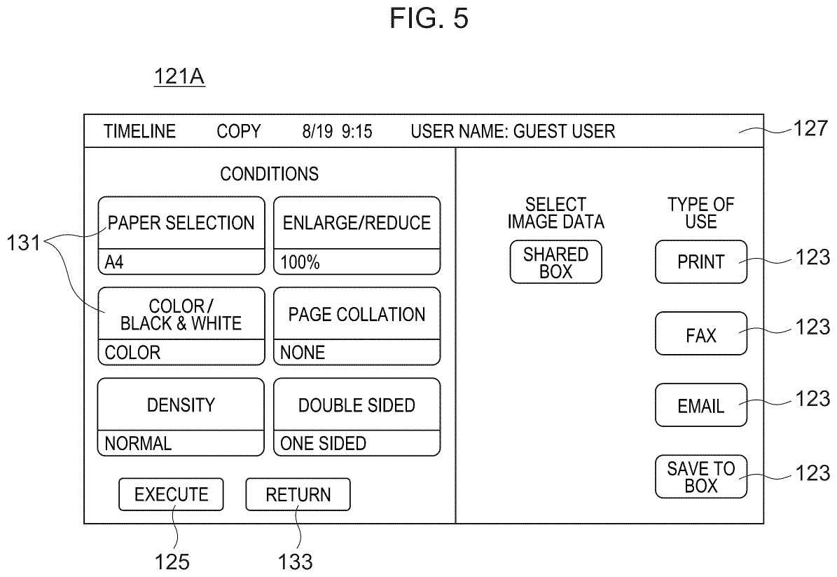

Operation of the image processing device 1 differs when an authenticated user uses the image processing device 1 and when an unauthenticated user uses the image processing device 1. The former case will be described first with reference to FIG. 3 and FIG. 4, and then the latter case will be described with reference to FIG. 5.

FIG. 3 illustrates an example of a home screen 101 that is displayed on the operation panel 9 when authentication performed by operating the login screen 151 is successful. In other words, FIG. 3 illustrates an example of the home screen 101 that is displayed to an authenticated user.

The home screen 101 includes multiple function buttons 107 on the left side of the drawing and multiple history buttons 109 on the right side of the drawing. When any one of the function buttons 107 is tapped, the screen displayed on the operation panel 9 switches to a screen for setting and executing the image processing indicated on the tapped function button 107 (for example, “copy”).

The multiple history buttons 109 contain (display) information regarding image processing (functions) performed in the past. For example, the date and time when the image processing was performed, the type of image processing (e.g., “copying” or “printing”), and the conditions of the image processing (e.g., paper size) are displayed. When any one of the history buttons 109 is tapped, the screen displayed on the operation panel 9 switches to a history use screen 121 (FIG. 4), for example. The history use screen 121 is a screen for allowing history information corresponding to that history button 109 to be used.

FIG. 4 is a diagram illustrating an example of the history use screen 121 displayed on the operation panel 9 for an authenticated user. More precisely, an example of the history use screen 121 for when the history button 109 positioned uppermost, among the three history buttons 109 illustrated in FIG. 3, is selected is illustrated.

The history use screen 121 displays image processing conditions on the left side of the drawing and displays image data (thumbnail 129) on the right side of the drawing for image processing that has been performed in the past. By tapping any one of the use buttons 123 displayed to the right of the thumbnail 129, the authenticated user can perform the image processing (such as “printing”) displayed on the tapped use button 123 on the displayed image data using the displayed processing conditions. In other words, the authenticated user can use the image data and processing conditions from the past image processing in new image processing.

Furthermore, the authenticated user can change the image data on which image processing is to be performed and/or change some or all of the processing conditions by operating the history use screen 121, and then tap the use button 123 to perform the new image processing. In other words, the authenticated user can reuse either or both of the image data and processing conditions handled in the past image processing. Furthermore, if the authenticated user selects the use button 123 for a type of image processing different from the type of image processing performed in the past, the authenticated user can use the image data and/or processing conditions used in the past image processing to perform a type of image processing different from the type of image processing performed in the past. For example, the authenticated user can use image data on which “scanning” has been performed in “printing”.

On the other hand, when the “guest user” button is operated on the login screen 151 in FIG. 2, a home screen that is similar to that in FIG. 3 (for convenience, the symbols in FIG. 3 may be used in the description) is displayed. In other words, multiple function buttons 107 and multiple history buttons 109 are displayed. The differences from the home screen 101 displayed to an authenticated user will be described below. The description of the home screen 101 in FIG. 3 may be basically applied to the home screen displayed to an unauthenticated user.

FIG. 5 is a diagram illustrating an example of a history use screen 121A displayed on the operation panel 9 for an unauthenticated user.

The history use screen 121A displays the image processing conditions on the left side of the drawing for image processing that has been performed in the past. However, on the history use screen 121A, on the right side of the figure, image data related to past image processing is not displayed, and an image prompting the unauthenticated user to select image data is displayed. The unauthenticated user selects image data that has been saved in advance from a shared box, which is described below, by performing a prescribed operation on the history use screen 121A. From another perspective, the image data that can be selected at this time does not include image data related to past image processing (specific type of image data).

After that, operations that are basically the same as or similar to those performed on the history use screen 121 can be performed. For example, the unauthenticated user can tap any one of the use buttons 123 displayed on the right side of the drawing to perform the image processing displayed on the tapped use button 123 on the selected image data using the displayed processing conditions. In other words, the unauthenticated user can use the processing conditions from past image processing for new image processing. In addition, the unauthenticated user can also change some or all of the processing conditions by operating the history use screen 121A, and then tap any one of the use buttons 123 to perform new image processing.

As described above, the image processing device 1 (CPU 11, controller) allows the authenticated user to access a specific type of image data (in the example above, image data from past image processing) in the storage unit 13 and processing information (information indicating the processing mode of past image processing) in the storage unit 13 via the history buttons 109. On the other hand, the image processing device 1 denies the unauthenticated user access to the specific type of image data via the history buttons 109, while allowing the unauthenticated user to access processing information via the history buttons 109.

Therefore, the authenticated user can use the image data and/or processing conditions from past image processing to perform new image processing. This saves the authenticated user the trouble of needing to newly set image data and/or processing conditions. In other words, convenience is improved for an authenticated user. In addition, for example, the unauthenticated user can use the processing conditions from past image processing to perform new image processing. As a result, the same as or similarly to the authenticated user, the unauthenticated user is not required to newly set processing conditions and convenience is improved for the unauthenticated user. On the other hand, security is improved by denying the unauthenticated user access to the specific type of image data.

An overview of the image processing device 1 according to an embodiment has been described above. Hereafter, an embodiment will be briefly described in the following order.

1. Terminology, etc.

2. Configuration of image processing device 1 (FIG. 1)

3. Login authentication

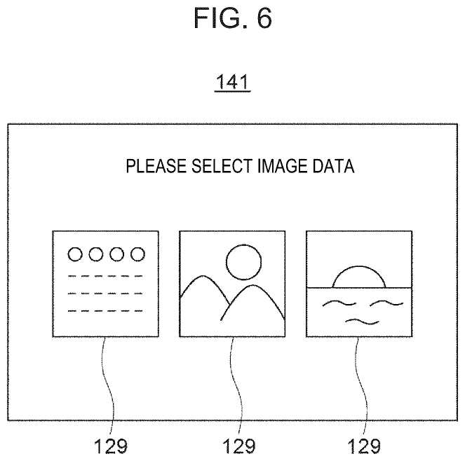

4. Examples of types of images
4.1. Login screen (FIG. 2)
4.2. Home screen for authenticated user (FIG. 3)
   4.2.1. Home screen in general
   4.2.2. Main region
   4.2.3. Timeline region
4.3. Home screen for unauthenticated user
4.4. History use screen for authenticated user (FIG. 4)
   4.4.1. History use screen in general
   4.4.2. Display related to new types of image processing
   4.4.3. Display related to image data
   4.4.4. Display related to setting items (processing conditions etc.)
4.5. History use screen for unauthenticated user (FIG. 5)
4.6. Image data selection screen (FIG. 6)

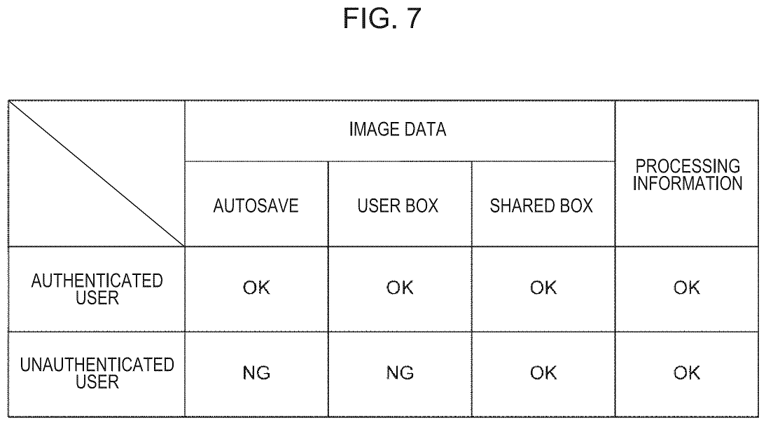

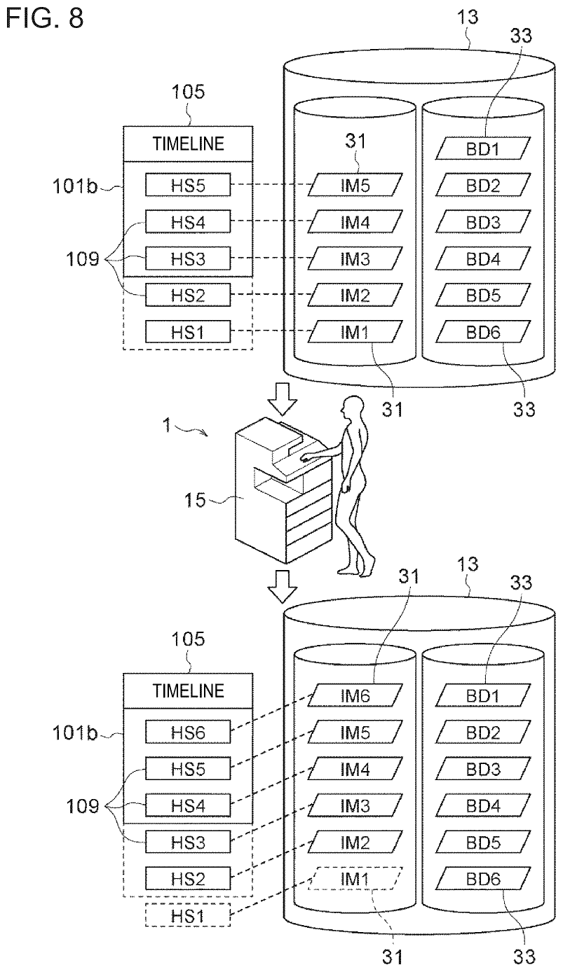

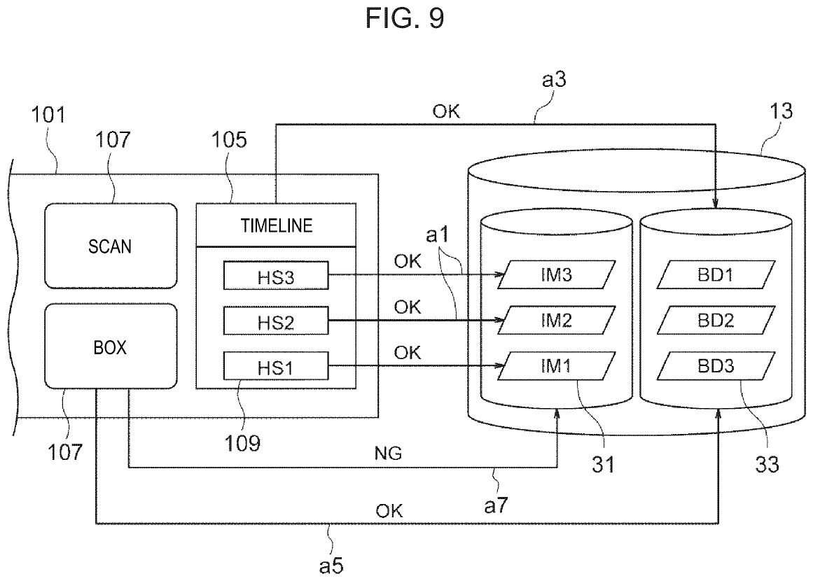

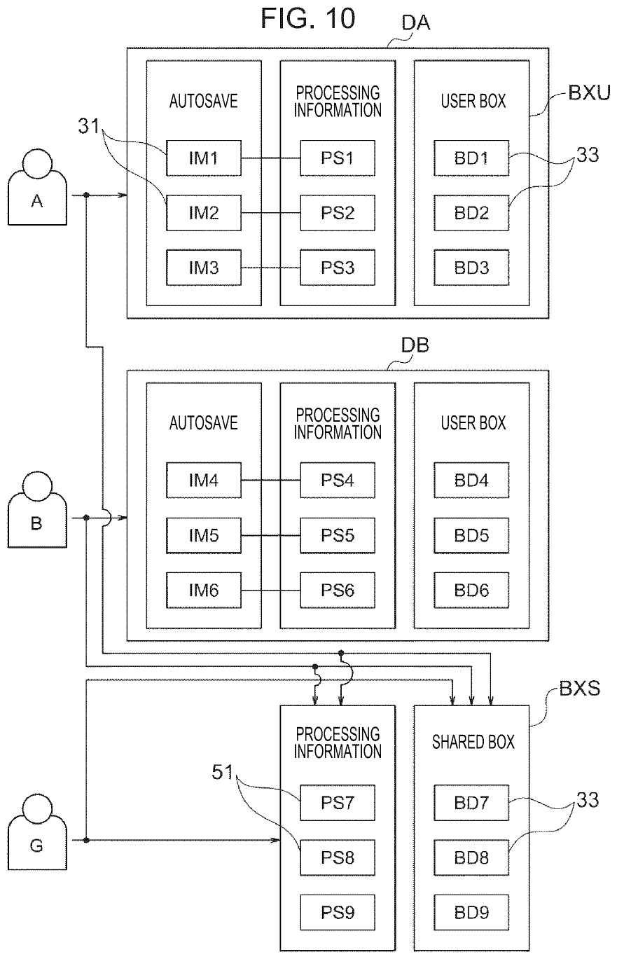

5. Types of data to which access is permitted or denied
5.1 Overview of types of data (FIG. 7)
5.2. Image data in box
5.3. Automatically saved image data (FIGS. 8 and 9)
5.4. Processing information
5.5. Data of each user (FIG. 10)
5.6. Supplementary information on types of data accessed

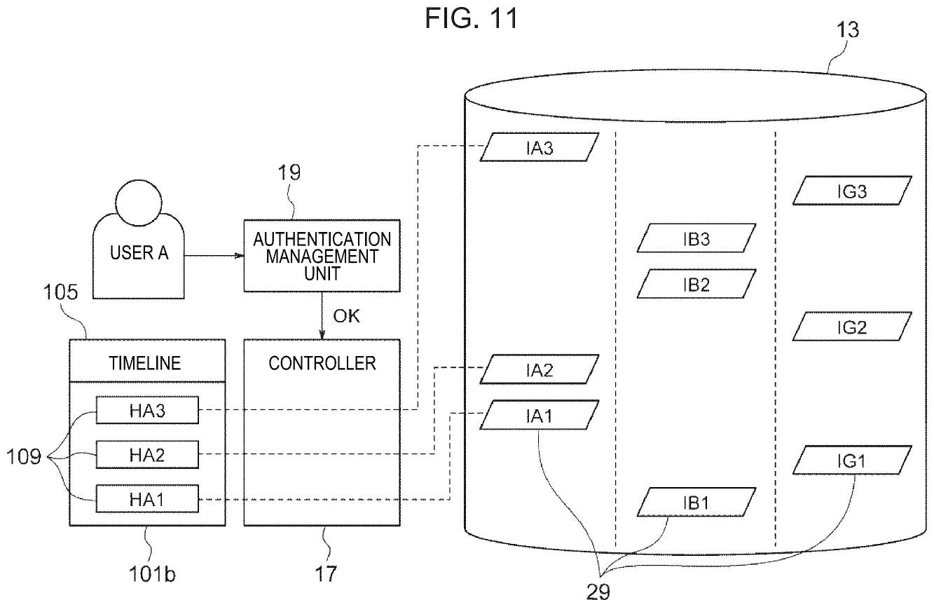

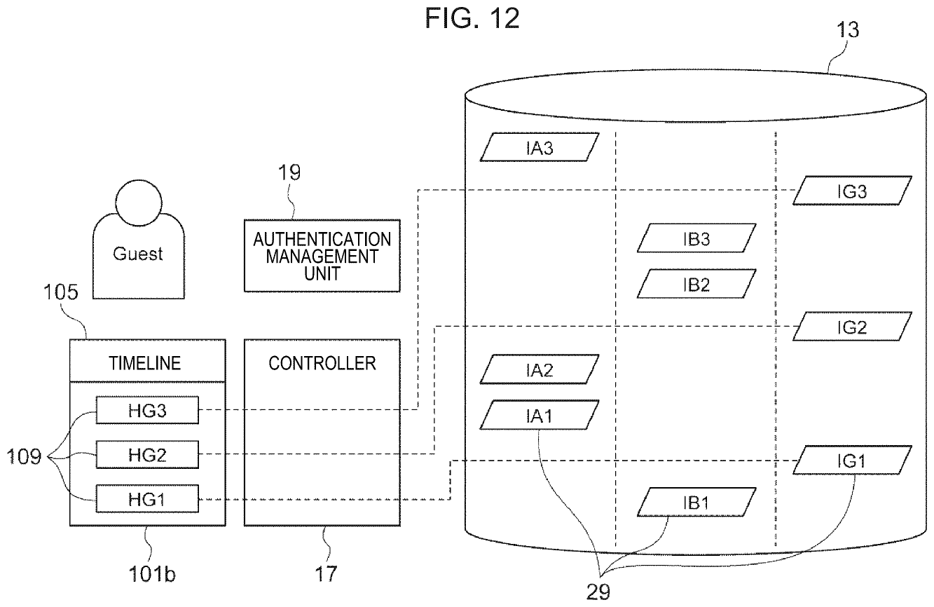

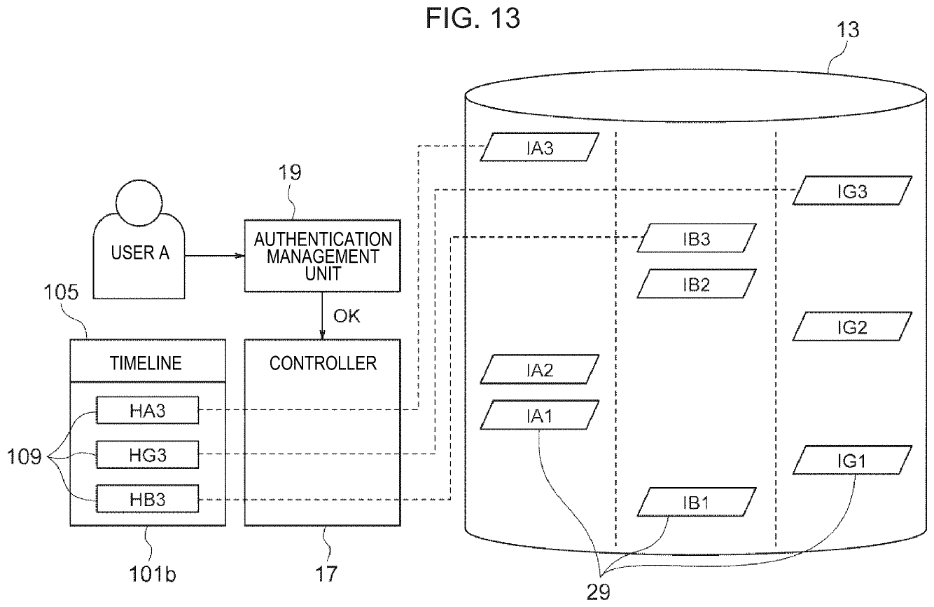

6. Display of history and access mode according to type of user
6.1. First example (FIGS. 11 and 12)
   6.1.1. Display in first example
   6.1.2. Access in first example
6.2. Second display example (FIG. 13)
   6.2.1. Display in second example
   6.2.2. Access in second example
6.3. Supplementary information on access to data

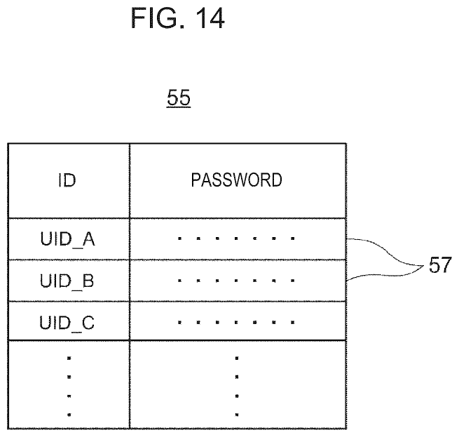

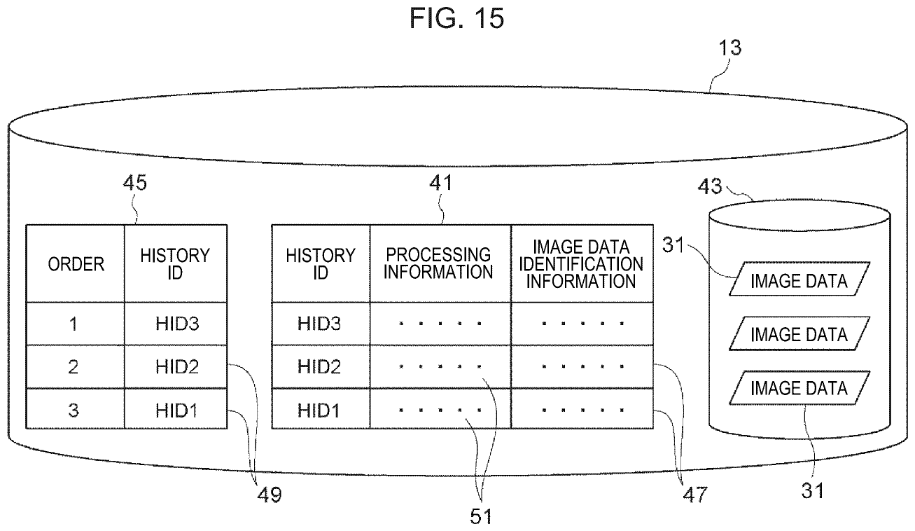

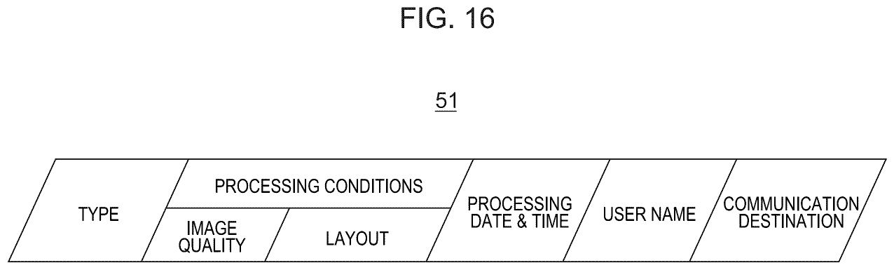

7. Data configuration
7.1 Configuration of authentication data (FIG. 14)
7.2. Configuration of data relating to history (FIGS. 15 and 16)

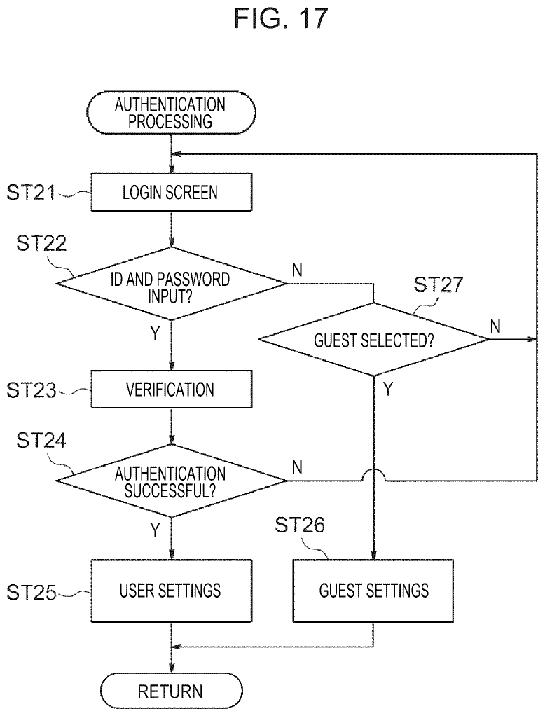

8. Example of procedure of processing executed by image processing device 1 (FIGS. 17 to 19)

9. Summary of embodiments

### 1. Terminology, Etc.

An “image” may contain only text. “Image data” may be in various formats, for example, may be in a vector format or a raster format. In the description of the embodiments, “image” and “image data” are not always strictly distinguished from each other for the sake of convenience.

“Image data” may be converted to other formats as appropriate while image processing is being performed. For example, image data may be in different formats when stored in the image processing device 1 and when image processing (for example, printing or faxing) is performed. However, in the description of the embodiments, for convenience, description of such format conversions may be omitted and the image data before and after conversion may be described as being identical. Furthermore, as can be understood from the above description, the format of “image data” is not limited to what is generally considered to be an image data format, and may be what is generally considered to be a document data format. The image data may be altered such that the quality of the image is changed or a portion of the image is cropped, for example, when image processing is performed. In such cases, the description of the embodiments may sometimes not distinguish between the image data before and after being altered for the sake of convenience.

The information displayed in the various sections of the various screens of the operation panel 9 (for example, the history buttons 109) may be displayed in the form of text and/or symbol images. In the description of the embodiments, for example, when information is displayed on the operation panel 9 or when a section (button, etc.) displayed on the operation panel 9 contains information, the information may be displayed in the form of text and/or symbol images so long as there are no particular inconsistencies and so on. Examples of sections where information is displayed include, for example, various buttons such as the history buttons 109, the regions around these buttons, and title bars 115 and 127 (described below).

“Text” may refer to, for example, information displayed as a string of characters and/or information displayed based on text data. Therefore, for example, text may be a string of characters displayed based on image data, or may be a symbol or only one character displayed based on text data. A “symbol image” may refer to, for example, information displayed as a symbol or graphic and/or information displayed based on image data. Therefore, for example, a symbol image may be a symbol displayed based on text data, or may be one or more characters displayed based on image data. As can be understood from the above description, text and symbol images may be partially overlapping classifications.

The “buttons” displayed on the operation panel 9 do not need to resemble physical buttons. For example, a button may be indicated only by text and/or a symbol image and does not need to have a border surrounding the text and/or symbol image. From another perspective, for example, the boundary between the region where a user's operation is detected and the surrounding region does not need to be represented by an enclosing line or a difference in color.

In the description of the embodiments, for convenience, terms indicating specific modes such as “tap”, “double tap”, and “long tap” may be used to describe operations performed on the operation panel 9. However, these terms may be generically conceptualized as a “prescribed operation”.

The terms “history buttons” and “processing information” etc. may refer to history buttons and processing information as categories rather than individual, specific history buttons and processing information. From another perspective, these terms are sometimes used as generic expressions. For example, when we state that “an authenticated user is permitted to access ”the“ processing information via ”the“ history button, and an unauthenticated user is permitted to access ”the“ processing information via ”the“ history button”, the history button and processing information for an authenticated user and the history button and processing information for an unauthenticated user may differ as individual specific objects even if the type of button referred to as the history buttons and the type of information referred to as the processing information are the same. For example, in FIGS. 11 and 12 described below, the specific history buttons 109 displayed to authenticated users and unauthenticated users are different, but as described above, expressions using “the” may be used as described above.

An ID, which is information identifying a user (or, from another perspective, an account having the right to log in), and authentication information (for example, a password) may be shared by multiple persons (or, from another perspective, organizations). Therefore, for example, unless otherwise specified or unless there is a contradiction, the term “user” can be interpreted as referring to not only an individual, but also multiple people.

The term “authenticated user” can refer to a user who has been successfully authenticated and is currently logged in (authenticated user in a narrow sense), or can refer to all of an authenticated user in the narrow sense described above, users who have been successfully authenticated and logged in in the past, and/or users who may be successfully authenticated in the future (authenticated user in the broad sense). Please interpret this term in a narrow or broad sense depending on the context. In addition, since an authenticated user in the broad sense can be said to be a user whose ID or the like is registered in advance in the image processing device 1 or the like, the authenticated user can be referred to as a registered user.

### 2. Configuration of Image Processing Device

The image processing device 1 illustrated in FIG. 1 includes the operation panel 9 and is configured to be capable of performing one or more types of image processing. The specific configurations used may be any of various configurations, and, for example, known configurations may be used except for configurations relating to the history buttons 109. In this embodiment, as has already been mentioned, the printer 3, the scanner 5, and the communication unit 7 are provided as configurations for performing image processing. Embodiments differing from this embodiment include, for example, an embodiment including only one out of the printer 3 and scanner 5, and an embodiment not including the communication unit 7. The configurations of the parts (3, 5, 7, 9, 11, and 13) of the image processing device 1 may also be any of various configurations, for example, may be known configurations with the exception of configurations related to the history buttons 109.

The image processing device 1 includes, for example, the housing 15. The housing 15 houses the various previously mentioned components (3, 5, 7, 9, 11, and 13). The image processing device 1 (housing 15 from another perspective) may be of any size and any shape. For example, the image processing device 1 may be of such a size (mass) as to be able to be carried by one person such as a home-use multifunction machine or printer, or may be of such as size (mass) as to not able to be carried by one person such as a commercial-use multifunction machine or printer. FIG. 8 described below schematically illustrates the exterior of a commercial multifunction machine as an example of the exterior of the image processing device 1.

The method of operation (or social role from another perspective) of the image processing device 1 may be any method of operation. For example, the image processing device 1 may be placed in a home for domestic or personal use, may be placed in a company for use by specific users and multiple users, or may be placed in a store such as a convenience store for use by an unspecified number of users.

The printer 3 may have any configuration. For example, the printer 3 may be configured to perform printing on paper (sheet paper from another perspective) disposed in a tray, which is not illustrated, and eject the paper after printing. The printer 3 may include only one tray or multiple trays. Multiple trays, for example, contribute to accommodating paper of different sizes. From another perspective, the printer 3 may or may not have a function of selecting the paper size. In the description of the embodiments, the former case is taken as an example. The printer 3 may be configured to be capable of printing in color (and monochrome and grayscale), may be configured to be capable of printing only in grayscale (and monochrome), or may be configured to be capable of printing only in monochrome. In the description of this embodiment, a configuration capable of printing in color is taken as an example.

For example, the printer 3 may be an inkjet printer that prints by ejecting ink, a thermal printer that prints by heating thermal paper or an ink ribbon, or an electrophotographic printer (for example, a laser printer) that transfers toner attached to a photoreceptive medium irradiated with light. The inkjet printer may be a piezoelectric printer in which pressure is applied to the ink by a piezoelectric body, or a thermal printer in which pressure is applied to ink by bubbles created in ink to which heat is applied. For example, the printer 3 may be a line printer in which the head has a length that spans the width of the paper (in a direction that intersects a paper transport direction), or may be a serial printer in which the head moves in the width direction of the paper.

Although not specifically illustrated, for example, the scanner 5 performs scanning by capturing an image of a document placed on a document glass by using multiple image-capturing elements that move along the document glass under the document glass.

The communication unit 7 realizes communication between the image processing device 1 and other devices. Examples of other devices include personal computers (PCs), mobile terminals (for example, smartphones), other image processing devices, and servers. Examples of servers include file servers, mail servers, and web servers. Communication may be performed directly with other devices or indirectly over a network. Examples of networks include telephone networks, the Internet, private networks, and local area networks (LANs). The communication may be wired communication, wireless communication, short-range communication, or long-range communication.

The image processing device 1 may be configured to be capable of performing any one or more of the various types of communication described above. In the description of this embodiment, a mode in which the image processing device 1 can perform various types of communication as described above will be taken as an example. Although not specifically illustrated, the communication unit 7 includes various components for realizing the various types of communication described above. The communication unit 7 may be considered to include only a hardware configuration (for example, a connector, an antenna, an amplifier, a filter, and a radio-frequency (RF) circuit), or may be considered to include a software configuration (a functional unit created by a CPU executing a program) in addition to the hardware configuration.

The operation panel 9 includes a touch panel, as already mentioned. Although not specifically illustrated, the touch panel includes a display device and a position input device that overlaps a screen of the display device. The display device and the position input device may have any configurations.

For example, the display device may be configured with a liquid crystal display or an organic EL (electroluminescence) display. These displays contain a relatively large number of regularly arranged pixels and can display images containing any shapes based on image data. The display device may be capable of displaying color images, may be capable of displaying only grayscale images (and monochrome images), or may be capable of displaying only monochrome images (binary images).

In addition, for example, the position input device may be an electrostatic position input device or a pressure sensitive position input device. An electrostatic position input device detect changes in the electrostatic capacitance of the screen and/or the vicinity thereof due to contact with or proximity of a finger or pen. A pressure-sensitive position input device detects pressure exerted on the screen. In addition, the position input device may utilize surface acoustic waves, infrared light, or electromagnetic induction. The position input device may or may not require a dedicated pen.

In the description of this embodiment, for convenience, operations performed on the operation panel 9 (operations performed on software buttons and so on) may be described under the assumption that contact is made. However, as understood from the above description, an operation may be detected without contact being made.

The CPU 11 constructs a functional unit that executes various types of processing by executing programs stored in the storage unit 13. An example of such a functional unit is a controller 17 (FIG. 11 etc.). The controller 17 controls operation of the printer 3, the scanner 5, the communication unit 7, and the operation panel 9. In addition to the part constructed by the CPU 11, the controller 17 may also include logic circuits configured to perform only certain operations.

Although not specifically illustrated, for example, the storage unit 13 includes various types of memory such as a ROM (read only memory), a RAM (random access memory), and an auxiliary storage device. The combination of the CPU 11 and the storage unit 13 may be regarded as a computer. The program that the above-mentioned CPU 11 uses to build the controller 17 is stored, for example, in the ROM and/or auxiliary storage device of the storage unit 13.

The various components (3, 5, 7, 9, 11, and 13) described above are connected to each other by a bus 21, for example. In FIG. 1, all the components are schematically connected to a single bus 21. In an actual product, multiple buses may be connected in any appropriate manner. For example, address buses, data buses, and control buses may be provided. Crossbar switches and/or link buses may also be used. An interface, which is not illustrated, may be interposed between the bus 21 and various components (3, 5, 7, and 9, and so on).

FIG. 1 is merely a schematic diagram. Therefore, for example, multiple CPUs and storage units (or controllers from another perspective) may be provided in a distributed manner. For example, a CPU (from another perspective, a controller that controls a corresponding component) in each component (3, 5, 7 and/or 9) and a higher-level CPU (a higher-level controller that controls the controllers in the individual components) may be provided. In such a case, the controller 17 may be regarded as a higher-level controller or the controller 17 may be regarded as a combination of controllers of the individual components and a higher-level controller. As can be understood from the above description, the controller 17 and the components (3, 5, 7, and/or 9) do not necessarily need to be clearly distinguishable from each other.

### 3. Login Authentication

As described in the overview of the embodiment, the image processing device 1 operates according to an authentication (verification) result of whether or not the user has the right (account) to log into the image processing device 1 (or, from another perspective, whether or not the user has a prescribed authorization to use the image processing device 1). Authentication can also be said to be an operation of confirming whether or not the user is a user who has been registered in advance.

The image processing device 1 may not only perform different operations depending on whether or not the user is an authenticated user, but may also perform different operations for different authenticated users. Examples of different authenticated users include different users having the same authorization level as each other and users having different authorization levels from each other. In this embodiment, description of differences in operation due to differences in authorization level is basically omitted. Basically, a general authenticated user is assumed as an authenticated user, and an authenticated user having a high authorization level (for example, an administrator) is not assumed.

The authentication method may be any one of various methods, for example, a known method. For example, authentication may be performed by inputting an ID (information identifying a user) and a password via the operation panel 9. In the description of the embodiment, this method is mainly taken as an example. For example, the authentication may be biometric authentication performed based on a user's biometric information detected by a detection unit, which is not illustrated, of the image processing device 1. Examples of the biometric information include a fingerprint or an iris. In addition, for example, the authentication may be card authentication performed based on communication between a card reader, which is not illustrated, of the image processing device 1 and an IC (integrated circuit) card of the user. Card authentication may be static authentication or dynamic authentication. The authentication may be performed based on information read out from a storage medium (for example, a USB memory) connected to a connector, which is not illustrated, of the image processing device 1. For example, the authentication may be performed based on communication between the communication unit 7 of the image processing device 1 and a terminal (for example, mobile terminal) of the user.

Note that among the example authentication methods listed above, except for authentication via the communication unit 7, the authentication methods are methods in which authentication is performed via the action of user input made to a user interface unit (for example, the operation panel 9, a detection unit for biometric information, a card reader, or a connector) of the image processing device 1. In addition, input of an ID can be omitted in the authentication methods described above, with the exception of authentication based on a password.

The substantial part of the authentication (for example, verification) may be performed by the image processing device 1 itself (for example, an authentication management unit 19 illustrated in FIG. 11 described below). However, the image processing device 1 may transmit authentication information to a server (not illustrated) via the communication unit 7, allow the server to perform verification, and use the result to grant authorization to the user. In other words, the image processing device 1 (authentication management unit 19) only needs to grant authorization based on the authentication result, and does not need to perform authentication itself. In the description of this embodiment, for convenience, the image processing device 1 may be assumed to perform authentication. As long as no contradictions arise, the term “image processing device 1” or “authentication management unit 19” may be replaced by the term “server” (which is a broad concept including other image processing devices, etc.) with respect to authentication.

The image processing device 1 may receive a signal containing a print job or the like from another device (for example, a PC) via the communication unit 7 and perform image processing. In addition, for such image processing, the data that can be accessed may differ depending on whether or not the user is an authenticated user. In such a case, authentication may be performed using various methods. For example, an ID and a password may be transmitted from another device to the image processing device 1 (or a server), biometric information may be transmitted from another device to the image processing device 1, or a static key, a private key, a public key, and/or an electronic certificate may be used between another device and the image processing device.

The ID and authentication information (for example, a password or biometric information) are stored in advance in a database of the image processing device 1 (or a server) in association with each other, for example, by an operation performed by an administrator or individual user at the image processing device 1. Then, when an operation for authentication is performed by a user, the image processing device 1 refers to the database and performs authentication.

The image processing device 1 may perform processing for logging out in response to an appropriate trigger. Examples of such a trigger include an operation for logging out performed on the operation panel 9, no operation (such as an operation to instruct image processing) being performed on the operation panel 9 for a prescribed period of time, and detection of the absence of the user by a motion sensor or the like.

### 4. Examples of Various Screens

Hereafter, examples of screens displayed on the operation panel 9 (FIGS. 2 to 6) will be described. In the description of the screens, operation of the image processing device 1 will also be described as appropriate.

### (4.1. Login Screen)

The login screen 151 illustrated in FIG. 2 can be said to be a screen that prompts the user to input information for authentication. As described above, here, a mode in which authentication is performed using an ID and a password is taken as an example. The specific content of the login screen may be changed as appropriate depending on the authentication method.

The login screen 151 is displayed across the entire operation panel 9, for example. However, a display prompting the user for information for authentication may be realized in a mode other than a login screen. For example, a function button 107 for login may be displayed on the home screen 101. Then, in response this function button 107 being tapped, a window (that is smaller than the operation panel 9) that performs display prompting the user to input information for authentication may be launched. In addition to the above window, the function button 107 for login may also be considered as display prompting the user to input information for authentication.

As described in the description of the overview of the embodiment, the login screen 151 may be displayed, for example, before the home screen 101. When the authentication is successful or use as an unauthenticated user is selected, the home screen 101 is displayed instead of the login screen 151. However, as can be understood from the description in the previous paragraph, the login screen 151 (or another display prompting the user to login) does not need to be displayed before the home screen 101. For example, the home screen 101 may be switched to the login screen 151 by tapping the function button 107 for login described in the previous paragraph. In this mode, the image processing device 1 may perform an operation for an unauthenticated user, for example, when authentication via the function button 107 for login is not performed.

The login screen 151 illustrated in FIG. 2 prompts the user to input an ID and a password (in other words, account information) by displaying “please enter your ID and password” at the top of the login screen 151. The user can select the input fields associated with “ID” and “password” by tapping or other operations, and then input characters (which is a broad concept including numbers and symbols) by operating mechanical switches or a software keyboard. As already described, the “execute” button is then tapped. In addition, as already described, instead of the above operation, the “guest user” button may be tapped.

Although not specifically illustrated, when authentication fails, the login screen 151 may be displayed again after or together with a message stating that fact.

### (4.2. Home Screen for Authenticated User)

### (4.2.1. Home Screen in General)

The home screen 101 illustrated in FIG. 3 is displayed when login authentication is successful, as already described. However, as also already described, the home screen 101 may be displayed from the start. More specifically, for example, the home screen 101 may be launched when the image processing device 1 is powered on and/or when the image processing device 1 returns from a sleep mode. Regardless of whether the home screen 101 is displayed before or after authentication, the home screen 101 can be expressed as a screen that is displayed when the user starts using the image processing device 1.

In a mode in which authentication is performed prior to the display of the home screen 101, the specific display contents of the home screen 101 may be different or the same for an authenticated user and an unauthenticated user, and may or may not be different for each authenticated user. In the description of the embodiment, for convenience, a mode in which the contents of the home screen 101 are different for an authenticated user and an unauthenticated user, and are different for each authenticated user may be taken as an example, without being particularly mentioned. The home screen 101 illustrated in FIG. 3 is an example of such a mode.

Unlike in the above mode, in a mode in which the home screen 101 is displayed before authentication, the specific display contents of the home screen 101 do not depend on the user. In this case, the home screen 101 may be for an unauthenticated user (see FIG. 12 described later) or may be shared by both authenticated users and unauthenticated users (see FIG. 13 described later). In the former case, when the authentication is subsequently successful, the specific display contents of the home screen 101 may be switched to those for an authenticated user. In the latter case, when the authentication is successful, the specific display contents of the home screen 101 may or may not be switched to those for an authenticated user. In a mode where the display contents are switched, the specific display contents of the home screen 101 may or may not be different for each authenticated user.

In a mode in which the specific display contents of the home screen 101 differ depending on the presence or absence of authentication or differ for each authenticated user, the differences may appear in any regions. For example, there may be differences related to the function buttons 107 and/or there may be differences related to the history buttons 109. In the description of the embodiment, mainly, an example of a mode in which there are differences related to the history buttons 109 will be described, and a description of a mode in which there are differences related to the function buttons 107 will basically be omitted.

The home screen 101 illustrated in FIG. 3 is displayed, for example, to span across the entire screen of the operation panel 9. The home screen 101 includes, for example, a main display region 101a and a timeline display region 101b. The main display region 101a displays a portion of a main region 103. The range occupied by the portion of the main region 103 may be indicated by a scroll bar 111. The timeline display region 101b displays a portion of a timeline region 105. The range occupied by the portion of the timeline region 105 may be indicated by a scroll bar 113.

The main region 103 includes the above-mentioned multiple function buttons 107. The timeline region 105 includes the above-mentioned multiple history buttons 109. In addition, the home screen 101 may include other appropriate sections such as the title bar 115 located at the top. The main region 103 and the timeline region 105 will be described below in order.

### (4.2.2. Main Region)

The display mode of the main region 103 and the processing executed when any one of the function buttons 107 is selected may be any of various modes and processing, and may be the same as or similar to known modes and processing, for example.

In the example in FIG. 3, a portion of the main region 103 is displayed in the main display region 101a, as previously described. Unlike in the illustrated example, the entire main region 103 may be displayed in the main display region 101a. From another perspective, the multiple function buttons 107 may be provided in a number greater than the maximum number that can be simultaneously displayed (illustrated example) or in a number less than the maximum number. In the mode in which a portion of the main region 103 is displayed in the main display region 101a, the direction in which the main region 103 is scrolled (left or right in the illustrated example) may be chosen as appropriate.

The multiple function buttons 107 are for selecting any one function from among different functions (image processing functions from another perspective). The function buttons 107 display information about their corresponding functions. “Copy”, “print”, “scan”, “fax” (facsimile), “email”, and “box” are illustrated as examples of functions in FIG. 3. When any one of the function buttons 107 is tapped, for example, the screen displayed on the operation panel 9 is switched to a screen for performing operations related to the function corresponding to that function button 107. The operations related to the function are, for example, an operation for executing image processing and an operation for setting the conditions for the image processing (for example, the size of paper when making a copy).

The number of function buttons 107 and the types of functions corresponding to the function buttons 107 may be set as appropriate. The types, number, positions, and so on of the function buttons 107 may be different or the same for authenticated users and unauthenticated users, and may or may not be different for each authenticated user. The types, number, positions, and so on of the function buttons 107 may be set by an authenticated user.

The types of function buttons 107 illustrated in FIG. 3 are described below. Note that, hereafter, the function buttons 107 may be referred to using the text displayed inside the function buttons 107. This also applies to other buttons (use buttons 123 and so on).

“Copy” is for setting settings related to and/or executing a function of printing images scanned by the scanner 5 using the printer 3 (copy function).

“Print” is, for example, for setting settings related to and/or executing a function of printing images based on data stored on a recording medium (not illustrated) connected to the image processing device 1 using the printer 3. The storage medium is, for example, a USB (universal serial bus) memory. Note that in the description of the embodiment, unless otherwise noted or unless there are any contradictions, when the term “print” is mentioned, the term is not limited to referring to printing performed using the “print” function button 107. (For example, printing performed in response to reception of a print job from the outside may be included.) (This also applies to the “print” use button 123 described below.)

“Scan” is for setting settings related to and/or executing a function of saving images scanned by the scanner 5 as data. The storage destination is, for example, an auxiliary storage device (nonvolatile memory from another perspective) included in the storage unit 13, a storage medium connected to the image processing device 1, or another device that communicates with the image processing device 1 via the communication unit 7. Note that, in the description of embodiments, unless noted otherwise or unless there are any contradictions, the term “scan” is not limited to referring to scanning performed using the “scan” function button 107 (for example, scanning performed during copying may be included).

“Fax” is for setting settings related to and/or executing faxing. When transmitting a fax, for example, an image of a document to be transmitted is scanned by the scanner 5, and the data of the scanned image is transmitted by the communication unit 7. When receiving a fax, for example, image data is received by the communication unit 7 and printing based on the received image data is performed by the printer 3.

“Email” is for setting settings relating to electronic mail and/or executing electronic mail. In this function, for example, part or all of the contents of an email received by the communication unit 7 may be printed by the printer 3. And/or the data of an image scanned by the scanner 5 may be included in an email transmitted by the communication unit 7.

“Box” is, for example, for setting settings relating to and/or executing a function of browsing information of any number of pieces of data (e.g., image data) stored in an auxiliary storage device (non-volatile memory from another point of view) included in the storage unit 13, and performing prescribed processing (e.g., image processing) on selected data. Image processing related to the box function is, for example, printing, sending by fax, or sending by email.

Note that a logical storage area (a folder or directory from another perspective) used by the box function may also be called a “box”. Image data is saved in a box by, for example, selecting a box as a save destination when performing scanning using the image processing device 1, sending data from a communication terminal to the image processing device 1, or copying data from a storage medium connected to the image processing device 1 to the image processing device 1.

As already mentioned, for example, when any one of the function buttons 107 is tapped, the screen displayed on the operation panel 9 is switched to a screen (not illustrated) for performing operations related to the function corresponding to that function button 107. For example, when “copy” is tapped, multiple buttons for setting processing conditions, a button for instructing execution of copying, and a button for returning to the home screen 101 are displayed. The description of the history use screen 121 in FIG. 4 may be appropriately applied to the buttons for setting processing conditions. Then, when the button for instructing execution is tapped, copying is performed. After that, when the button for returning to the home screen 101 is tapped or when a certain amount of time has elapsed, the screen displayed on the operation panel 9 returns to the home screen 101 (or the login screen 151).

Note that, unlike in the above description, image processing (for example, copying) may be performed when the relevant function button 107 is tapped. The image processing conditions (for example, copying processing conditions) may be set on a dedicated screen for setting the processing conditions displayed in response to tapping a dedicated function button 107 for setting the processing conditions.

### (4.2.3. Timeline Region)

The display mode of the timeline region 105 may be any of various display modes, and for example, may be the same as or similar to known display modes. However, at least part of the processing performed when a prescribed operation (for example, a tap) is performed on the history buttons 109 is different from known processing.

The position, shape, and area of the timeline display region 101b may be freely chosen. In the example in FIG. 3, the timeline display region 101b is positioned on one side (the right-hand side in the illustrated example) in the horizontal direction of the rectangular home screen 101 (the entire screen of the operation panel 9 from another perspective), which has the horizontal direction as its longitudinal direction. The timeline display region 101b has a rectangular shape with the vertical direction being the longitudinal direction of its rectangular shape. The width of the timeline display region 101b is less than ½ or less than ⅓ the width of the home screen 101. The majority of the home screen 101, excluding the timeline display region 101b (for example, more than 80%), is made up of the main display region 101a.

In the example in FIG. 3, a portion of the timeline region 105 is displayed in the timeline display region 101b, as described previously. Unlike in the illustrated example, the entire timeline region 105 may be displayed in the timeline display region 101b. From another perspective, the number of history buttons 109 may greater than the maximum number that can be simultaneously displayed (illustrated example) or less than or equal to the maximum number that can be simultaneously be displayed. In a mode in which a portion of the timeline region 105 is displayed in the timeline display region 101b, the direction in which the timeline region 105 is scrolled (up and down in the illustrated example) may be any direction.

The multiple history buttons 109 are, for example, arranged in a single row in a prescribed direction in the order of the date and time image processing operations corresponding to the history buttons 109 were executed. The arrangement direction of the history buttons 109 may be any direction. In the example in FIG. 3, the arrangement direction is the vertical direction of the home screen 101, the longitudinal direction of the timeline display region 101b, and the direction in which the timeline region 105 is scrolled. The multiple history buttons 109 may be arranged from one side to the other side in the arrangement direction (from top to bottom in the illustrated example), in order from newest to oldest, or may be switchable between from newest to oldest and from oldest to newest by performing prescribed an operation on the operation panel 9. In the description of this embodiment, for convenience, the history buttons 109 are assumed to be arranged in order from newest to oldest.

When image processing is executed via an operation performed on a function button 107 or when image processing is executed via an operation performed on a history button 109 (and use button 123 (FIG. 4)), a new history button 109 is added for that image processing. If the image processing that led to the addition of a history button 109 is the same as new image processing that was performed via an operation performed on that history button 109, the history button 109 may be added anew, or the date and time of the executed image processing corresponding to the operated history button 109 may be updated (from another perspective, the display position of the history button 109 may be changed). The image processing operations referred to here may be identical, for example, except for the date and time of execution. However, other differences may exist besides the date and time of execution. Unlike in the description of this embodiment, processing to add or update a history button 109 does not need to be performed for image processing executed via an operation performed on a history button 109.

The types of image processing for which the history buttons 109 are generated may be any type of image processing. For example, even if the image processing device 1 has the six functions illustrated on the home screen 101, the history buttons 109 do not need to be generated for all of them. For example, the history buttons 109 may be generated only for image processing in which printing is performed by the image processing device 1, such as “copy” and “print” (and printing using “box”). In addition, the history buttons 109 may be generated only for image processing in which scanning is performed by the image processing device 1 such as “copy”, “scan”, “fax”, and “email”. The history buttons 109 may be generated only for image processing in which no communication takes place, for example, “copy”, “print” and “scan” (and printing using “box”).

For image processing that is performed by transmitting a signal including a print job, etc., from another device (for example, a PC) to the communication unit 7, a history button 109 may or may not be added. If a history button 109 is added, for example, the user who sent a print job from a PC to the image processing device 1 can reprint the job via the history button 109 when he or she observes a print failure in front of the image processing device 1. In the description of this embodiment, basically, description of the addition of history buttons 109 accompanying this type of image processing whose execution is instructed via communication with the outside is omitted. In a mode where a history button 109 is added, in the description of this embodiment, so long as there are no contradictions or the like, an instruction for executing image processing using a signal from the outside may be added to the place where an instruction for executing the image processing using the operation panel 9 is described.

The number of history buttons 109 provided in the timeline region 105 is limited to being no more than a prescribed upper limit. In other words, the number of history buttons 109 (including those displayed by scrolling) that can be displayed in the timeline display region 101b is limited to being no more than the prescribed upper limit. Thus, for example, when the history buttons 109 are added as described above, if an additional new history button 109 is to be added after the number of history buttons 109 has reached the upper limit, the oldest history button 109 will be deleted. In other words, the oldest history button 109 cannot be displayed. Consequently, the image data and processing information associated with that history button 109 will become essentially inaccessible.

The specific value of the upper limit may be set to any value and is 5, 10, or 20, for example. The upper limit may be set by the manufacturer of the image processing device 1 and may be unchangeable by the administrator or user of the image processing device 1, or may be set by the administrator of the image processing device 1. In a mode where the display mode of the timeline region 105 can be made different for each authenticated user, the upper limit may be settable by an authenticated user.

If the number of history buttons 109 has not reached the upper limit, the display mode may be any display mode. For example, only a number of history buttons 109 below the upper limit may be displayed, or dummy history buttons (for example, history buttons that do not display information thereinside) may be displayed together with the history buttons 109 so that in total the upper limit number of history buttons is displayed. In the former mode, the length of the timeline region 105 may or may not vary in accordance with the number of history buttons 109.

The image processing device 1 may be capable of operating differently from described above with respect to the addition, deletion, and arrangement of the history buttons 109. For example, by performing an operation (for example, a long tap or a double tap) on any history button 109 that is different from the operation performed when switching to the history use screen 121, deletion of that history button 109 may be denied, that history button 109 may be made to be always disposed above the most recent history button 109, or that history button 109 may be deleted. In the description of this embodiment, in order to make the description more concise and easier to understand, the descriptions or wordings may assume that such operations are not performed.

The multiple history buttons 109 may, for example, have the same shape and size as each other (illustrated example), or may have different shapes and/or sizes from each other. An example of the latter is a mode in which the multiple history buttons 109 have different shapes and/or sizes from each other depending on the type of image processing (differences such as copying or scanning).

Each history button 109 contains (displays) information on the corresponding image processing. As described above, this information may include, for example, the date and time when the image processing was performed, the type of image processing, and the conditions of the image processing. In the example in FIG. 3, the user name of the person who performed the image processing (“xxxx” is illustrated as a schematic representation of a string of characters) is also displayed.

Other examples include, for example, a communication destination (sender and/or receiver) in the fax function and/or email function. Information on the image data handled in the image processing may also be displayed on the history buttons 109. Information on the image data may include, for example, the size of the image data, the type of image as determined by the image processing device 1 (for example, document or not document), and the name given to the image data by the image processing device 1.

Each history button 109 may display at least one or more pieces of information out of the various pieces of information about image processing (for example, date and time, type, processing conditions, and user name) described above. In a mode in which the image processing conditions are displayed inside the history buttons 109, the specific conditions to be displayed may be appropriately selected from among various conditions. In FIG. 3, the color condition (“color” and “black & white” are given as examples), the magnification setting (“100%” is given as an example), and the paper condition (“A4” and “auto” are given as examples) are illustrated.

The history buttons 109 may contain the same type of image processing information (in other words, the items displayed on the history buttons 109), or may contain different types of image processing information from each other. For example, the types of information displayed on the history buttons 109 may vary depending on the type of image processing. More specifically, for example, a history button 109 in which the type of image processing is copying does not include an entry for displaying a communication destination, whereas a history button 109 in which the type of image processing is fax or email may include an entry for displaying the communication destination.

### (4.3. Home Screen for Unauthenticated User)

As already mentioned, the general layout of the home screen for an unauthenticated user is the same as the basic layout of the home screen for an authenticated user. Therefore, the description of the home screen 101 for an authenticated user may be basically applied to the home screen for an unauthenticated user. As already mentioned, the more specific display contents may be different or the same as each other for the home screen for an unauthenticated user and the home screen 101 for an authenticated user, and in the description of the embodiment, the former case may be taken as an example without being specifically mentioned. As already mentioned, the differences between the specific display contents for an authenticated user and an unauthenticated user may appear in any region, but in the description of this embodiment, only the differences in the timeline region 105 will be described for convenience. These differences will be described later (see Section 6).

### (4.4. History Use Screen for Authenticated User)

### (4.4.1. History Use Screen In General)

As already mentioned, in the history use screen 121 illustrated in FIG. 4, new image processing can be performed by tapping the use buttons 123. More specifically, in the illustrated example, when any one of the use buttons 123 is tapped, the type of image processing corresponding to the tapped use button 123 is selected. Then, when an execute button 125 is tapped, the selected type of image processing is performed.

The history use screen 121 may include (or display) the following, for example, in addition to the use buttons 123 and the execute button 125. The title bar 127 of the history use screen 121. The thumbnail 129 depicting image data to be the target of new image processing. One or more settings buttons 131 for confirming and setting setting items such as image processing conditions. A return button 133 for returning to the home screen 101. The settings buttons 131 may be used to check and set setting items other than processing conditions (for example, the communication destination). However, hereafter, the processing conditions may be taken as examples unless otherwise noted.

Any layout may be adopted for the various sections described above, and FIG. 4 merely illustrates one example. In the example in FIG. 4, generally speaking, a region in which the multiple use buttons 123 are arranged, a region in which the thumbnail 129 is displayed, and a region in which the multiple settings buttons 131 are arranged are provided. These three regions are arranged in the above order, from right to left.

### (4.4.2. Display Related to New Types of Image Processing)

As described above, the multiple use buttons 123 are provided according to the types of image processing to be newly performed using the information on the past image processing related to the history button 109 selected on the home screen 101. In FIG. 4, “print”, “fax”, “email”, and “save to box” are illustrated as examples of types of image processing. These types of image processing are the same as, similar to, or correspond to the types of image processing corresponding to the function buttons 107 on the home screen 101. However, the image data to be subjected to the image processing is the image data selected via the history buttons 109 and/or the history use screen 121. The functions of the use buttons 123 illustrated in FIG. 4 are as follows.

“Print” is for printing an image based on the selected image data using the printer 3. “Fax” is for transmitting the selected image data from the communication unit 7 by fax. “Email” is for transmitting the selected image data from the communication unit 7 by email. “Save to box” is for storing the selected image data in an auxiliary storage device (non-volatile memory from another point of view) included in the storage unit 13 so that the image data can be used via the “box” function of the home screen 101.

Note that image data that is the target of the “print”, “fax” and “email” use buttons 123 may be image data automatically saved following execution of past image processing (described later), and/or may be image data saved in a box. Image data that is the target of the “save to box” use button 123 is basically image data that has been automatically saved following execution of past image processing. However, data that is the target of “save to box” may be data saved in a box. In this case, for example, data in a specific box can be copied to another box. In addition, “save to box” may be used to save processing information related to processing conditions, etc.

Note that the use buttons 123 are merely one example of a display for selecting new types of image processing. The new types of image processing may be displayed in other ways. For example, instead of providing multiple use buttons 123 corresponding to multiple types of image processing, the type of image processing may be set using one settings button 131, the same as or similar to the setting of setting items (processing conditions) using the settings buttons 131 described later.

In addition, unlike in the illustrated example, new types of image processing may not be selectable. For example, the types of image processing executed via the history buttons 109 may be limited to the types of past image processing corresponding to the history buttons 109. In the description of the embodiment, a case in which new types of image processing are selectable may be taken as an example without being specifically mentioned.

### (4.4.3. Display Related to Image Data)

The thumbnail 129 is displayed, for example, based on the currently selected image data. As described above, the selected image data is image data handled in image processing corresponding to the history button 109 immediately after the history use screen 121 is displayed in response to the history button 109 on the home screen 101 being selected. The image data can be changed by performing a prescribed operation on the history use screen 121.

However, the manner in which image data is selected may be different from that described above. For example, the image data may be in an unselected state immediately after the history use screen 121 is displayed. For example, a screen the same as or similar to the history use screen 121A for an unauthenticated user may be displayed. That is, the data selected by selecting the history button 109 on the home screen 101 may be only processing information related to the processing conditions, and so on.

Note that, in the case of extracting an invention with a different feature from the features described in the overview of the embodiment from the present disclosure, the image data accessible via the history buttons 109 may not be selectable (changeable). In other words, the accessible image data may be limited to the image data handled in the past image processing corresponding to the selected history button 109.

The display, operation method, and so forth of the screen for selecting image data may be freely chosen. For example, in the example in FIG. 4, by tapping the thumbnail 129, a window or screen for selecting image data may be displayed. The specific form may be freely chosen. For example, the form may be the same as or similar to that of a window or screen for selecting data in a known box function. An example will be given later (Section 4.6).

The display mode of the thumbnail 129 may be the same as or similar to that of the display of image data by data browsing software for a PC, the display of image data on a web page, etc., for example. Specifically, for example, pixels may be averaged so that the entire image based on the image data is displayed in the region allocated to the thumbnail 129. In addition, a portion of an image spanning multiple pages (for example, the first page) may be displayed, or a portion of a single image may be displayed (trimming may be performed).

Thus far, we have described that image data may be used via the use buttons 123 and the execute button 125. The display of the thumbnail 129 may also be regarded as an example of a method of using image data corresponding to the history button 109. From another perspective, access to image data via the history buttons 109 does not need to be via the use buttons 123 and the execute button 125.

The thumbnail 129 can also be displayed without accessing the corresponding image data when the history button 109 is selected. For example, when a new history button 109 is generated, image data for the thumbnail 129 may be generated in advance with a smaller data size relative to the original image data.

The thumbnail 129 is merely one example of a display showing image data used for new image processing. The image data may be displayed in a form other than the thumbnail 129. For example, a path (string of characters from another perspective) may be displayed instead of or in addition to the thumbnail 129.

### (4.4.4. Display Related to Setting Items (Processing Conditions, Etc.))

The multiple settings buttons 131 are provided so as to correspond to multiple setting items (for example, processing conditions), for example. When any one of the settings buttons 131 is tapped, for example, a screen or window allowing setting of the corresponding item is displayed on the operation panel 9. This allows, for example, the corresponding item to be changed from the current setting.

The setting states of various setting items immediately after the history use screen 121 is displayed in response to selection of a history button 109 on the home screen 101 are referred to as initial settings. As described above, the settings in the past image processing corresponding to the history button 109 are used as the initial settings. In addition, the setting states of various setting items can be changed by performing prescribed operations on the history use screen 121.

However, some or all of the multiple setting items may not be changeable. In addition, in the case of extracting an invention with a different feature from the features described in the overview of the embodiment from the present disclosure, the processing information (e.g., the type of processing and/or the processing conditions) related to the past image processing corresponding to the history button 109 may not be available for use.

In the illustrated example, as described above, a type of image processing different from the type of the past image processing can be executed. The different types of image processing do not necessarily have the same types of multiple setting items. Therefore, the initial settings may be set as appropriate in accordance with the type of image processing.

For example, when the type of the past image processing is the same as the type of the new image processing, the settings of the past image processing may be set as the initial settings for all of the multiple setting items. However, the past settings of the image processing may be used as the initial settings for only some of the multiple setting items. For the remaining setting items, for example, the initial settings (hereinafter, sometimes referred to as the default settings) set in advance by the manufacturer, administrator, or user of the image processing device 1 may be used.

Furthermore, for example, when the type of the past image processing is different from the type of the new image processing, the settings of the past image processing may be used as the initial settings for items that are the same or similar for the past image processing and the new image processing. For example, the processing conditions for copying illustrated in FIG. 4 can be used as the processing conditions for printing. For items that are not the same or similar, for example, the default settings described above may be used. Unlike in the above description, the default settings may be used for all setting items regardless of the presence or absence of the same or similar items.

Since the settable items (e.g., processing conditions) change depending on the type of image processing, the number and type of settings buttons 131 (in other words, setting items) displayed on the history use screen 121 may change. For example, when any one of the use buttons 123 is selected, only the settings buttons 131 corresponding to the settable items in the type of image processing corresponding to the selected use button 123 may be displayed. When any one of the history buttons 109 is selected on the home screen 101 and the home screen 101 transitions to the history use screen 121, for example, the use button 123 corresponding to the type of image processing corresponding to the history button 109 may be automatically selected, or any pre-determined use button 123 may be automatically selected, and only the settings buttons 131 corresponding to the above selection may be displayed.

Unlike in the above description, the number and types of settings buttons 131 displayed do not need to change. In this case, for example, some of the settings buttons 131 may indicate that they cannot be set for the type of image processing corresponding to the selected use button 123, or operations on some of the settings buttons 131 may be disabled in accordance with the selected use button 123. Some setting items (for example, setting items that have a low probability of being changed) may be set on a screen other than the history use screen 121 (for example, a screen corresponding to not displayed function buttons 107 for settings provided on the home screen 101).

Each settings button 131 displays information indicating the type of setting item corresponding to the button. Each settings button 131 may also display information indicating the setting status of the item corresponding to the button. In the illustrated example, the type of the setting item is displayed in the upper part of each settings button 131, and the current setting status of that item is displayed in the lower part of the settings button 131.

As can be understood from the previous description, the number and types of the settings buttons 131 may be freely chosen. In the example in FIG. 4, “paper selection”, “color/black & white”, “density”, “reduce/enlarge”, “page collation”, and “double sided” are illustrated as the settings buttons 131 when a history button 109 corresponding to copying has been selected. In the lower parts of the settings buttons 131, “A4”, “color”, “normal”, “100%”, “not set”, and “single sided” are illustrated as examples of the current settings for these items. Since these are typical settings, description thereof is omitted.

### (4.5. History Use Screen for Unauthenticated User)

In the history use screen 121A illustrated in FIG. 5, instead of a display showing the selected image data (for example, the thumbnail 129 in FIG. 4), a display is shown that prompts the selection of image data, for example. From another perspective, when an unauthenticated user selects a history button 109, the image data handled in the past image processing corresponding to the history button 109 is not in a selected state. Except for this point, the display contents of the history use screen 121A (and the operation of the image processing device 1 related to the history use screen 121A) are basically the same as or similar to those for the history use screen 121 (FIG. 4) for an authenticated user. Therefore, unless contradictions arise, the description related to the history use screen 121 may be applied to the history use screen 121A. In FIG. 4 and FIG. 5, the date and time of execution of the image processing and the user names are different from each other due to the selected history buttons 109 being different from each other.

The specific mode of the display that prompts the user to select image data may be freely chosen. In the illustrated example, a “shared box” button for opening a shared box is displayed together with the text “please select image data”. By tapping this button, for example, a window or screen for selecting image data is displayed. The specific form may be freely chosen. For example, the form may be the same as or similar to that of a window or screen for selecting data in a known box function. An example will be given later (Section 4.6).

A mode other than the illustrated example is, for example, displaying text such as “no image selected” in the arrangement region of the thumbnail 129 on a screen the same as or similar to the history use screen 121 in FIG. 4. Then, the same as or similar to the history use screen 121, by tapping the arrangement region of the thumbnail 129, a window or screen for selecting image data from the shared box may be displayed. In this way, a display prompting the user to select image data may be passive. In addition, for example, a list of one or more lower level boxes in a shared box and/or a list of one or more files in a shared box (in which buttons are arranged) may be displayed.

After image data is selected, for example, a screen the same as or similar to the history use screen 121 in FIG. 4 may be displayed. That is, an image showing the selected image data (thumbnail 129 in the example in FIG. 4) may be displayed. The operation of the image processing device 1 after that may be basically the same as the operation related to the history use screen 121.

### (4.6. Image Data Selection Screen)

FIG. 6 is a diagram illustrating an example of a screen 141 (or window) displayed on the operation panel 9 when an operation is performed on the history use screen 121 or 121A to select (change and/or initially select) image data to be subjected to new image processing.

The screen 141 displays thumbnails 129 based on image data that can be selected by the user. The user selects image data to be used in new image processing by performing a prescribed operation (e.g., tapping) on any one of the thumbnails 129. Once the image data is selected, the screen of the operation panel 9 returns to, for example, the history use screen 121. The subsequent operations are as described above.

### 5. Types of Data to Which Access is Permitted or Denied

### (5.1. Overview of Types of Data)

FIG. 7 is a table showing an overview of the types of data to which access via the history buttons 109 is permitted or denied.

As described above, data to which access is permitted or denied via the history buttons 109 includes image data and processing information (information on the type of processing and/or processing conditions, etc.). Image data includes data that has been automatically saved following the execution of past image processing (“auto save” in the drawing) and data saved in a box (“user box” and “shared box” in the drawing). Automatic saving will be described later (Section 5.3). Examples of boxes include a user box that can only be accessed by a user associated with that box, and a shared box that can be accessed by any user.

As described above, the image processing device 1 allows an authenticated user to access a specific type of image data via the history buttons 109, while denying an unauthenticated user access to the specific type of image data via the history buttons 109. In the example in FIG. 7, the specific type of image data is image data that has been automatically saved and image data in a user box. Any user, including unauthenticated users, is allowed to access the image data in a shared box via the history buttons 109. As described above, any user, including unauthenticated users, is allowed to access the processing information.

### (5.2. Image Data in Box)

As described above, a box is, for example, a logical storage area used by the box function (in other words, the function button 107 in FIG. 3). However, a box may be defined as a logical storage area that can be accessed via the history buttons 109 and in which image data is stored by a method other than auto-save in association with image processing. In other words, a box does not need to be intended for use by the box function. The method of saving to such a box may be the same as or similar to the method of saving in a box intended for use by the box function (as described above). In the description of the embodiment, the description is made with the assumption that the box can be used by the box function (function button 107).

As boxes, a box that can only be accessed by authenticated users (hereinafter referred to as a “non-shared box”) and a shared box that can be accessed by any user including unauthenticated users may be provided. However, only a shared box may be provided. In addition, in the case of extracting an invention with a different feature from the feature described in the overview of the embodiment from the present disclosure, only a non-shared box may be provided.

As non-shared boxes, boxes that can be accessed by all authenticated users, boxes each of which can be accessed by multiple authenticated users associated with that box, and/or user boxes each of which can only be accessed by one authenticated user associated with that box may be provided. In the description of the embodiment, a user box is mainly taken as an example.

### (5.3. Automatically Saved Image Data)

FIG. 8 is a schematic diagram for describing image data automatically saved following image processing. FIG. 8 also illustrates an example of operation of the image processing device 1 for an authenticated user.

In the upper part of FIG. 8, the timeline region 105 is schematically illustrated on the left side. Here, the timeline region 105 includes the maximum number of history buttons 109 that can be displayed (taken to be five for convenience) (labeled with symbols such as “HS1” to “HS5” for convenience). Out of the history buttons 109, the three history buttons 109 surrounded by a solid line (“HS5” to “HS3”) are located in the timeline display region 101b, and the remaining two history buttons 109 surrounded by a dotted line (“HS2” and “HS1”) are located in a not-displayed region.

In addition, in the upper part of FIG. 8, the storage unit 13 is schematically illustrated on the right side. The storage unit 13 stores, for example, the same number of pieces of image data 31 (labeled with symbols such as “IM1” to “IM5” for convenience) as the maximum number of history buttons 109 that can be displayed. The image data 31 may be stored in either the RAM or auxiliary storage device in the storage unit 13. In other words, the image data 31 may be stored in either volatile memory or nonvolatile memory.

In the middle part of FIG. 8, a situation is schematically illustrated in which image processing is performed by an authenticated user operating the image processing device 1. For example, copying, printing, scanning, faxing, or emailing is performed by operating the function buttons 107 on the home screen 101 or the use buttons 123 on the history use screen 121.

Thus, a new history button 109 “HS6” corresponding to the above image processing is added (made displayable), as illustrated in the lower part of FIG. 8. The oldest history button 109 “HS1” is deleted (made not displayable), as indicated by the dotted line. At this time, the image data 31 (“IM6”) handled in the above image processing is newly stored in the storage unit 13. In other words, the image data 31 “IM6” corresponding to the history button 109 “HS6” is newly stored. In addition, the image data 31 “IM1” corresponding to the history button 109 “HS1” is deleted.

More strictly speaking, the image data 31 “IM6” can be stored at least in RAM prior to image processing in order to perform image processing based on that data. “Newly stored” in the above description may refer to, for example, being stored prior to image processing as described above, may refer to being newly stored separate from being stored prior to image processing, or may refer to storage of information (for example, an address) about the image data 31 “IM6” in a suitable table so as to be available via the appropriate history button 109. Deletion of the image data 31 “IM1” may refer to deletion of the image data 31 or may refer to the deletion of information about the image data 31 “IM1” (for example, address) from the appropriate table so as to be no longer available via the history button 109.

Deletion of the image data 31 “IM1” may mean writing other information over the storage area where the image data 31 was stored or initializing the storage area. In other words, deletion of the image data 31 may make the image data 31 unrecoverable. Deletion of the image data 31 may also include deleting the information of the address of the storage area where the image data 31 is stored. In other words, although the image data 31 cannot be accessed by an operation performed by the user on the image processing device 1, there is a possibility that the image data 31 could be recovered by a specialist. The image data 31 “IM6” may be stored in the storage area where the image data 31 “IM1” was stored or in a different storage area.

In this way, the image data 31 is basically automatically newly stored at the timing of the image processing. From another perspective, the image data 31 is basically associated with the history button 109 when the image processing is carried out. From yet another perspective, the image data 31 is basically stored temporarily. From yet another perspective, the image data 31 is different from image data (e.g., image data 33 related to the box function) that is stored or deleted by an operation that is directly intended to store or delete the image data.

Let us assume that a history button 109 is selected, new image processing is performed on the same image data as the image data handled in the past image processing corresponding to the selected history button 109, and the selected history button 109 and the history button 109 for the new image processing coexist. At this time, two (or more) identical pieces of image data 31 corresponding to two (or more) history buttons 109 may coexist, or one piece of image data 31 may be associated with two (or more) history buttons 109 (no new storage may be performed).

As described above, any history button 109 may be deleted through an operation performed by an authenticated user. At this time, the image data 31 corresponding to the deleted history button 109 may also be deleted. As described above, the deletion of any history button 109 through an operation performed by an authenticated user may be denied. In this case, the image data 31 corresponding to that history button 109 may continue to be stored as long as the history button 109 can be displayed.

The image data 31 may be stored in either volatile memory or nonvolatile memory, as previously mentioned. In a mode in which the image data 31 is stored in volatile memory, the image data 31 may be deleted, for example, when the power of the image processing device 1 is turned off (or shifted to sleep mode). In conjunction with this, the timeline region 105 may be initialized the next time the image processing device 1 is turned on (or returns from sleep mode). In a mode in which the image data 31 is stored in a non-volatile memory, for example, the continuity of the timeline region 105 may be maintained before and after the power is turned off and on (or the sleep mode) unless a prescribed initialization operation is performed. However, the image data 31 stored in nonvolatile memory may be deleted when the power is turned off (or shifted to sleep mode), and the timeline region 105 may be accordingly initialized.

In FIG. 8, multiple pieces of image data 33 (denoted by symbols “DB1” to “DB6” for convenience) used by the “box” function button 107 are illustrated for comparison with the image data 31. Unlike the image data 31, the image data 33 is essentially stored independently of updating of the history buttons 109 that can be displayed. From another perspective, the image data 33 is not automatically stored, for example, when copying or printing is performed, but is stored when an operation is performed to store the image data in the storage unit 13, as already described. The image data 33 basically remains stored (is not automatically deleted) unless the image data 33 is deleted, for example, by an operation performed on the “box” function button 107.

When image processing related to the addition of a history button 109 uses the image data 33 in a box, image data 31 may or may not be automatically saved. In the latter case, the image data 33 may be associated with the history button 109 instead of the image data 31. In the former case, only the image data 31 may be associated the history button 109, or both the image data 31 and 33 may be associated with the history button 109.

In this embodiment, when an unauthenticated user uses the image processing device 1, the image data 31 is not automatically saved. Security is ensured by making the image data 31 of an authenticated user accessible only to the authenticated user. On the other hand, the image data 31 is not generated for an unauthenticated user, and therefore an authenticated user or other unauthenticated users cannot access the image data 31, and security is ensured.

However, in a mode different from this embodiment, the image data 31 may be automatically saved for an unauthenticated user.

FIG. 9 is a schematic diagram for describing the image data 31 and 33 from the viewpoint of access methods. FIG. 9 also illustrates an example of a mode in which access is permitted and denied for authenticated users.

On the left side of FIG. 9, a portion of the home screen 101 is illustrated in a more schematic manner than in FIG. 3. Here, the timeline region 105 includes the history buttons 109 “HS3” to “HS1”. Whether or not the history buttons 109 are located in the timeline display region 101b is not taken into consideration here. The storage unit 13 is schematically illustrated on the right side of FIG. 9, similarly to as in FIG. 8. However, the number of pieces of image data 31 (“IM1” to “IM3”) corresponding to the history buttons 109 and the number of pieces of image data 33 (“BD1” to “BD3”) corresponding to the box function are illustrated in smaller numbers than in FIG. 8.

As previously described, and as indicated by arrows al labeled with the word “OK”, the controller 17 allow access to the image data 31 via operations performed on the history buttons 109 (For example, reading of the image data 31. Same applies to description of FIG. 9). Furthermore, as indicated by an arrow a3 with the word “OK” attached, the controller 17 allows access to the image data 33 via an operation performed on the history buttons 109 and the history use screen 121.

As indicated by an arrow a5 with the word “OK” attached, the controller 17 allows access to the image data 33 via an operation performed on the “box” function button 107. On the other hand, as indicated by an arrow a7 labeled with the word “NG”, the controller 17 denies access to the image data 31 via an operation performed on the “box” function button 107.

Thus, operations for accessing the image data 31 related to automatic saving and the image data 33 related to a box are different from each other. For example, the image data 31 related to automatic saving cannot be accessed (for example, displayed and/or deleted) through other operations that are not via operations performed on the history buttons 109. Other operations (operations on the “box” function button 107 in the above example) can be expressed as operations for accessing image data 33 different from the image data 31 corresponding to the history buttons 109. From another perspective, the other operations include operations performed on buttons (function buttons 107) that are displayed together with the history buttons 109 on the home screen 101.

### (5.4. Processing Information)

The description of the automatically saved image data 31 made with reference to FIGS. 8 and 9 may be applied to the processing information so long as there are no contradictions. For example, the processing information is automatically saved with execution of image processing, and is deleted with the deletion of the corresponding history button 109. For example, the processing information can be accessed via the history button 109, while access via the “box” function button 107 is denied.

However, while the image data 31 is automatically saved when image processing is performed by an authenticated user, the processing information is automatically saved not only when the image processing is performed by an authenticated user but also when the image processing is performed by an unauthenticated user. This is because usually there is no problem if the processing information is accessed by other users.

The automatically saved processing information may include all or only part of the information (setting items) required for image processing. The required information may include items set on a screen other than the history use screen 121. The automatically saved processing information may include all or only some of the multiple setting items displayed on the history use screen 121 in a resettable manner.

The contents of the automatically saved processing information may be different for an authenticated user and an unauthenticated user. For example, information that is to be kept secret from unauthenticated users (e.g., communication destination) may not be automatically saved. In this way, the same as or similarly to the image data 31, the security of information that an authenticated user wishes to keep secret is ensured by making the information accessible only to the authenticated user, and the security of information that unauthenticated users wish to keep secret is ensured by not automatically saving the information.

### (5.5. Data for Each User)

FIG. 10 is a schematic diagram illustrating examples of types of data to which access is permitted or denied from the viewpoints of individual users.

In FIG. 10, data for authenticated users A and B and data for an unauthenticated user G are illustrated. In addition, the description regarding the authenticated user A may be applied to the authenticated user B by swapping A and B provided that no contradictions arise. Furthermore, in the image processing device 1, the unauthenticated user G is treated as one unauthenticated user G (the same person from another viewpoint) even if they are, for example, different people or organizations (unauthenticated users are not distinguished from each other). In FIG. 10, for convenience, the pieces of automatically saved image data 31 are labeled “IM1” to “IM6”, the pieces of automatically saved processing information 51 are labeled “PS1” to “PS9”, and the pieces of box image data 33 are labeled “BD1” to “BD9”.

The image processing device 1, for example, automatically saves the image data 31 and the processing information 51 in association with the corresponding authenticated users. In addition, as described above, a user box is provided for each authenticated user. Therefore, the image processing device 1 can store the automatically saved image data 31 and processing information 51, as well as the image data 33 in a user box BXU, for each authenticated user. In FIG. 10, data DA stored in response to operations performed by the authenticated user A and data DB stored in response to operations performed by the authenticated user B are illustrated.

The image processing device 1 automatically saves the processing information 51 in response to operations performed by the unauthenticated user, as described above. Among the pieces of processing information 51 in FIG. 10, “PS7” to “PS9” are related to image processing performed by the unauthenticated user. The image processing device 1 can store the image data 33 in a shared box BXS in response to operations by authenticated users and the unauthenticated user G.

In FIG. 10, the arrows extending from the users indicate the data that the users can access. Each authenticated user is permitted to access the data DA or DB corresponding thereto, and is denied access to the data DA or DB corresponding to other authenticated user. The unauthenticated user is denied access to the data DA and DB of the authenticated users. In addition, all users are permitted to access the processing information 51 of image processing performed by unauthenticated users and the image data 33 in the shared box BXS.

### (5.6. Supplementary Information on Types of Data Accessed)

The specific type of image data that an authenticated user is permitted to access and an unauthenticated user is denied access to may be different from that illustrated in FIG. 7. For example, the specific type of image data may be only image data in a non-shared box (e.g., the user box). An example of such a mode is one in which the image data 31 is not automatically saved. In addition, for example, the specific type of image data may be only the automatically saved image data 31. Examples of such a mode include a mode in which a non-shared box is not provided, and a mode in which access to a non-shared box via the history buttons 109 is denied.

As already mentioned, instead of or in addition to user boxes corresponding to individual authenticated users, a non-shared box accessible by all authenticated users and non-shared boxes accessible by multiple authenticated users associated with each box may be provided. Although these boxes are not illustrated in FIG. 10, the image processing device 1 may allow access via the history buttons 109 to other non-shared boxes accessible by each authenticated user via the box function, in the same or a similar manner to the user boxes.

The automatically saved image data 31 and processing information 51 may not be associated with individual authenticated users, unlike in FIG. 10. In other words, only whether the image data 31 and processing information 51 is related to image processing performed by an authenticated user or an unauthenticated user is distinguished, and each authenticated user may be able to access the image data 31 and processing information 51 of other authenticated users.

### 6. Display of History and Access Mode According to Type of User

As already mentioned, the image processing device 1 may or may not change the history buttons 109 that are displayed according to the type of logged-in user. Examples of such display modes are given below. In addition, the mode of access to data in each display mode is described.

In this description, for convenience, the maximum number of history buttons 109 that the timeline region 105 can contain (the maximum number of history buttons 109 that can be displayed) may be expressed as though the number is the same as the number of history buttons 109 that are displayed in the timeline display region 101b. In other words, the timeline region 105 may be represented as though the entire timeline region 105 is displayed in the timeline display region 101b.

### (6.1. First Example)

### (6.1.1. Display in First Example)

FIG. 11 is a schematic diagram illustrating an example of the display of the history buttons 109 when the user is the authenticated user A.

In this example, in short, when the authenticated user A is successfully authenticated, the operation panel 9 displays the history buttons 109 only for image processing performed by the authenticated user A in the past. In other words, the history buttons 109 for image processing performed by other authenticated users and unauthenticated users are not displayed. FIG. 11 illustrates this situation in a schematic manner.

In FIG. 11, the following are given as examples of the image data 31 stored by the storage unit 13. Stored information 29 (“IA1” to “IA3”) relating to image processing previously performed by authenticated user A. Stored information 29 (“IB1” to “IB3”) relating to image processing previously performed by authenticated user B. Stored information 29 (“IG1” to “IG3”) relating to image processing previously performed by an unauthenticated user.

The stored information 29 of the authenticated user A or B is, for example, a combination of the image data 31 (or 33) and the processing information 51. In addition, the stored information 29 of the unauthenticated user G is, for example, the processing information 51 (in other words, does not include the image data 31).

In FIG. 11, the stored information 29 located at the top has the most recent processing date and time. That is, the stored information 29 is arranged in order from the newest to the oldest, as follows: “IA3”, “IG3”, “IB3”, “IB2”, “IG2”, “IA2”, “IA1”, “IG1”, and “IB1”.

The timeline region 105 includes the history buttons 109 (“HA1” to “HA3”) corresponding to the stored information 29 of the authenticated user A. The multiple history buttons 109 are arranged in order of their processing dates and times. In other words, from top to bottom, the timeline region 105 includes “HA3” corresponding to “IA3”, “HA2” corresponding to “IA2”, and “HA1” corresponding to “IA1”.

For such a display, the authentication management unit 19 of the image processing device 1 authenticates the user and grants the user authorization for image processing. The authentication management unit 19 is an example of various functional units realized by the CPU 11 (FIG. 1) executing a program stored in the storage unit 13 (for example, in ROM and/or auxiliary storage device). The granting of authorization may correspond to an operation of setting a prescribed flag, for example, inside the image processing device 1. The controller 17 then refers to the flag and performs the above-described display for the authorized user (i.e., authenticated user A).

Although not specifically illustrated, the display mode when the authenticated user B, not illustrated, is successfully authenticated is the same as or similar to that illustrated in FIG. 11. That is, the history buttons 109 corresponding to the stored information 29 “IB3”, “IB2”, and “IB1” are displayed in the timeline region 105 in order.

FIG. 12 is a schematic diagram showing an example of display of the history buttons 109 when the user is an unauthenticated user (guest user).

In this example, simply put, the operation panel 9 displays the history buttons 109 only for image processing performed in the past by unauthenticated users. In other words, the history buttons 109 related to image processing performed by authenticated users are not displayed. FIG. 12 illustrates this situation in a schematic manner.

In FIG. 12, the image data 31 stored in the storage unit 13 is the same as that in FIG. 11. The timeline region 105 includes the history buttons 109 (“HG1” to “HG3”) corresponding to the image data 31 of unauthenticated users. The multiple history buttons 109 are arranged in order of their processing dates and times. That is, from top to bottom, the timeline region 105 includes “HG3” corresponding to “IG3”, “HG2” corresponding to “IG2”, and “HG1” corresponding to “IG1”.

The image processing device 1 does not distinguish between unauthenticated users, for example, with respect to the functions related to the history buttons 109. A common timeline region 105 is displayed for multiple unauthenticated users (multiple people or organizations). In other words, when an authenticated user is not logged in, the operation panel 9 displays the history buttons 109 including information on past image processing performed by the current unauthenticated user and other unauthenticated users.

Regarding the display examples in FIGS. 11 and 12, the deletion of the image data 31 and the processing information 51 (stored information 29) described with reference to FIG. 8 etc. may be performed for each user, for example. For example, when the number of pieces of image data 31 for each user (each authenticated user or unauthenticated user) exceeds the maximum number of history buttons 109 that can be contained in the timeline region 105 (three in the illustrated example), the oldest piece of image data 31 out of the image data 31 of that user may be deleted. In other words, the total number of pieces of image data 31 of multiple users may exceed the maximum number of history buttons 109.

### (6.1.2. Access in First Example)

The operation of the image processing device 1 in the first example may be the same as or similar to the operation of the image processing device 1 described with reference to FIGS. 3 to 5, for example.

For example, the home screen 101 illustrated in FIG. 3 corresponds to the display mode in FIG. 11. When an authenticated user touches a history button 109 in FIG. 11, the history use screen 121 (FIG. 4) is displayed based on the stored information 29 (image data 31 and processing information 51) associated with the selected history button 109. The authenticated user A can change (select) image data to be the target of new image processing by operating the history use screen 121. However, the image data that can be selected is limited to, for example, image data 31 corresponding to the authenticated user A, image data 33 in a non-shared box that the authenticated user A is permitted to access (for example, the authenticated user's own user box BXU), and image data 33 in the shared box BXS. As image data that can be selected, the image data 31 corresponding to the authenticated user A may or may not be limited to that corresponding to the selected history button 109.

In addition, for example, when an unauthenticated user taps a history button 109 in FIG. 12, the history use screen 121A (FIG. 5) is displayed based on the stored information 29 (processing information 51) associated with the selected history button 109. Then, the unauthenticated user selects image data to be the target of new image processing by operating the history use screen 121A. However, the image data that can be selected is limited to, for example, the image data 33 in the shared box BXS.

(6.2. Second example)

### (6.2.1. Display in Second Example)

FIG. 13 is a schematic diagram illustrating a display example, which is different from that illustrated in FIG. 11, of the history buttons 109 when the user is the authenticated user A.

In this example, in short, when the authenticated user A is successfully authenticated, the operation panel 9 displays the history buttons 109 for the image processing performed by all users in the past. FIG. 13 illustrates this situation in a schematic manner.

In FIG. 13, the stored information 29 stored in the storage unit 13 is the same as that illustrated in FIG. 11. The timeline region 105 includes the history buttons 109 corresponding to the stored information 29 of all users within the range of the maximum number of history buttons 109 that can be displayed. The multiple history buttons 109 are arranged in order of their processing dates and times. That is, from top to bottom, the timeline region 105 includes “HA3” corresponding to “IA3”, “HG3” corresponding to “IG3”, and “HB3” corresponding to “IB3”. From another perspective, the history buttons 109 corresponding to other stored information 29 (for example, the history button 109 corresponding to “IA2”) are not displayed.

Although not specifically illustrated, unlike in the example in FIG. 13, when the authenticated user A is successfully authenticated, the history buttons 109 of two or more users, who are a portion of all the users and include the authenticated user A, may be displayed. For example, the image processing device 1 may operate so as to display only the history buttons 109 of all authenticated users and not display the history buttons 109 of unauthenticated users. In addition, for example, the image processing device 1 may possess a table in which individual users are associated with user groups, and may display the history buttons 109 of all authenticated users who belong to the user group to which the authenticated user A belongs.

The image processing device 1 may present only the display mode in FIG. 13 to the authenticated user A, or may selectively present the display mode in FIG. 11 and the display mode in FIG. 13 to the authenticated user A depending on a selection made by the authenticated user A. The display mode for the authenticated user B may be the same as or similar to the display mode for the authenticated user A, or only the display mode in FIG. 11 may be presented. In the latter implementation mode, the authenticated user A and the authenticated user B may be users having different levels of authorization.

In an implementation mode in which the display mode in FIG. 13 is presented to the authenticated user A, the display mode presented to an unauthenticated user may be that in FIG. 12 or that in FIG. 13, or the display mode in FIG. 12 or the display mode in FIG. 13 may be selectively presented in accordance a selection made by the unauthenticated user.

When the display mode in FIG. 13 is presented at least to the authenticated user A, the stored information 29 may be deleted as appropriate. For example, the deletion of the stored information 29 described with reference to FIG. 8 etc. may be performed for each user, the same as or similarly to as in FIG. 11 and FIG. 12. FIG. 13 illustrates such a mode, and the number of pieces of stored information 29 for each user is set to be the same as the maximum number of history buttons 109 (three in the illustrated example).

Assuming that only the display mode in FIG. 13 is presented to the authenticated user A (the display mode in FIG. 11 is not presented), the illustrated storage unit 13 also stores the stored information 29 that is not displayed on the history buttons 109 (e.g., “IA2” and “IA3”). In this way, all or part of the stored information 29 (e.g., image data 31 and/or processing information 51) stored in the storage unit 13 may not necessarily be able to be displayed on the history buttons 109. In this case, for example, as described later, access to the stored information 29 that is not displayed on the history buttons 109 may be permitted via the displayed history buttons 109. This also applies to the stored information 29 of other users.

However, in this mode as well, the stored information 29 may be at least automatically deleted in order from the oldest to newest as image processing is performed. That is, when the number of pieces of stored information 29 for each user exceeds a prescribed number (for example, any number greater than or equal to the maximum number of history buttons 109), the oldest piece of image data 31 for that user may be automatically deleted.

Unlike in the illustrated example, in a mode in which only the display mode in FIG. 13 is presented to an authenticated user, only the stored information 29 whose history can be displayed on the history buttons 109 may be stored. For example, in an implementation mode in which the display mode in FIG. 13 is presented to all users, only the stored information 29 “IA3”, “IG3”, and “IB3” may be stored.

### (6.2.2. Access in Second Example)

Even in the display mode in FIG. 13, for example, by tapping a history button 109, the history use screen 121 (or 121A) can be transitioned to, and the stored information 29 corresponding to the tapped history button 109 can be used.

More specifically, the authenticated user A can use the stored information 29 (image data 31 and processing information 51) corresponding to the history buttons 109 corresponding to the authenticated user A. The operation of the image processing device 1 at this time is the same as or similar to that in the first example.

For example, the operation when the authenticated user A taps the history buttons 109 corresponding to the authenticated user B is as follows. The image processing device 1 may deny access to all of the stored information 29 (image data 31 and processing information 51) by not displaying the history use screen 121 and so forth (example mainly described thus far). Alternatively, the image processing device 1 may permit access to the processing information 51 (part of the stored information 29) via a display similar to the history use screen 121A. However, image data that can be selected by the authenticated user A in this case would be limited, and a specific example of such a mode may be the same as or similar to that in the first example. In addition, unlike in the above example, the image processing device 1 may permit access to all of the stored information 29 (image data 31 and processing information 51) the same as or similarly to as when the history buttons 109 of the authenticated user A are tapped.

When the authenticated user A taps a history button 109 corresponding to an unauthenticated user, for example, the history use screen 121A (FIG. 5) is displayed using the stored information 29 (processing information 51) corresponding to the tapped history button 109. In other words, access to the processing information 51 of the unauthenticated user is permitted. However, the image data that can be selected by the authenticated user A after that is restricted, and an example of the specific mode may be the same as or similar to that in the first example.

The operation of the image processing device 1 when the display mode in FIG. 12 is displayed for an unauthenticated user is, for example, the same as or similar to that in the first example. In addition, when the display mode in FIG. 13 is displayed for an unauthenticated user, the operation when the unauthenticated user taps a history button 109 corresponding to the unauthenticated user is, for example, the same as or similar to that in the first example.

When the display mode in FIG. 13 is displayed for an unauthenticated user, the operation when the unauthenticated user taps a history button 109 corresponding to the authenticated user A is, for example, as follows. The image processing device 1 may deny access to all of the stored information 29 (image data 31 and processing information 51) by not displaying the history use screen 121 and so forth (example mainly described thus far). Alternatively, the image processing device 1 may permit access to the processing information 51 (part of the stored information 29) via a display similar to the history use screen 121A. However, the image data that can be selected by the unauthenticated user after that is restricted, and an example of the specific mode may be the same as or similar to that in the first example.

### (6.3. Supplementary Information on Access to Data)

As can be understood from the description of the first example, an unauthenticated user may be denied access to not only the image data of authenticated users, but also the processing information 51, for example, by not displaying the history buttons 109 of the authenticated users to the unauthenticated user. In addition, as can be understood from the description of the second example, unauthenticated users may be permitted to access the processing information 51 of authenticated users.

A user (authenticated user and/or unauthenticated user) may be able to access not only the stored information 29 corresponding to the history button 109 selected on the home screen 101, but also the stored information 29 (image data and/or processing information) corresponding to other history buttons 109 by operating the history use screen 121 or 121A. In this case, as can be understood from the description of the display example in FIG. 13, the stored information 29 may or may not be limited to the information for which the corresponding history button 109 is in a displayable state.

Denial of access to a specific type of image data for an unauthenticated user may be realized in the form of various modes, including those already exemplified, and may include, for example, any one of the following. When an unauthenticated user taps a history button 109 of an authenticated user in order to display the history use screen 121A, the thumbnail 129 based on the image data corresponding to the history button 109 is not displayed. Furthermore, even if an operation for selecting an image is performed (for example, tapping the “shared box” button on the history use screen 121A), only the shared box can be opened. That is, the screen 141 illustrated in FIG. 6 is not displayed for a box in which the specific type of image data is stored. From another perspective, displaying a list of data in a folder in which the specific type of image data is stored is denied. In addition, unlike in the above description, even if a list of data in the folder is permitted, an operation of selecting any of the data is denied. Alternatively, even if selecting any data from the list is formally permitted (from another perspective, on the display of the operation panel 9), performing image processing on the selected data is denied.

### 7. Data Configuration

The data stored by the image processing device 1 to realize the operations described thus far may be configured in various ways. Examples are described below.

### (7.1. Configuration of Authentication Data)

FIG. 14 is a schematic diagram illustrating an example of an authentication table 55 used for authentication (verification).

As previously mentioned, the example used here is a mode in which passwords are used as authentication information. As already mentioned, authentication (verification) may be performed by the image processing device 1, or by a server communicating with the image processing device 1 via the communication unit 7. In other words, the authentication table 55 may or may not be stored, for example, in the auxiliary storage device (in other words, nonvolatile memory) of the storage unit 13. However, in the description of this embodiment, the former is taken as an example.

The authentication table 55, for example, holds one or more pieces of registration data 57. Each piece of registration data 57 holds an ID and a password. That is, the authentication table 55 stores IDs and passwords in association with each other. Therefore, the authentication management unit 19 can authenticate a user based on whether or not a combination of an ID and a password input via the operation panel 9 is present in the authentication table 55.

Note that a “user name” is displayed on the home screen 101 etc. illustrated in FIG. 3. This “user name” may be the same as the ID, or may be a character string associated with the ID.

### (7.2. Configuration of Data Related to History)

FIG. 15 is a schematic diagram illustrating an example of the configuration of data related to the use of the history buttons 109. FIG. 15 illustrates an example of the configuration of data of the authenticated user A assuming the display example in FIG. 11. Data of other display examples and examples of the configuration of data of unauthenticated users can be inferred from FIG. 15.

The storage unit 13 may include the following tables or databases for example. A history table 41 that holds information about image processing performed in the past. An image database 43 that holds image data 31 (and/or image data 33 of a box) that was handled in image processing performed in the past. A display table 45 that holds information relating to display of the history buttons 109.

The history table 41 can hold one or more pieces of history information 47. One piece of history information 47, for example, holds information about one image processing operation carried out in the past. One piece of history information 47 holds (associates with each other), for example, “history ID” (ID: Identification), “processing information” (processing information 51), and “image data identification information”.

The “history ID” is information automatically assigned by the controller 17 to a piece of history information 47 when the piece of history information 47 is generated, for example, in order to allow multiple pieces history information 47 to be identified. The format of the history ID may be any format. In FIG. 15, “HID1” to “HID3” are illustrated as the contents of the history information 47 for convenience.

The “processing information” (processing information 51) is information about image processing (including information displayed on the settings buttons 131 for example). The specific content of the processing information 51 is illustrated later in FIG. 16. In FIG. 15, for convenience, rows of dots schematically representing strings of characters are illustrated.

The “image data identification information” is information for identifying the image data 31 (and/or 33) handled in the image processing corresponding to the history information 47. This allows access to the piece of image data 31 (and/or 33) corresponding to the selected piece of history information 47 when one of multiple pieces of history information 47 is selected. The image data identification information may be, for example, information of the address of the corresponding piece of image data 31 (and/or 33) or may be an ID associated with the information of the address. In FIG. 15, for convenience, rows of dots schematically representing strings of characters are illustrated.

The image database 43 holds multiple pieces of image data 31 (and/or 33). As can be understood from the above description of the “image data identification information”, the image database 43 may or may not include a table, which is not illustrated, that holds information of the address of a storage area where the image data 31 (and/or 33) is stored and the ID associated with the information of the address. Although referred to as a “database” for convenience, the image database 43 may or may not have a specific structure. For example, the image data 31 (and/or 33) may be stored by temporarily securing the necessary storage area and the information of the address may be just stored in the image data identification information.

The display table 45 can hold one or more pieces of display information 49, for example. One piece of display information 49 corresponds to one history button 109, for example. One piece of display information 49 holds (associates with each other), for example, “order” and “history ID”.

The “order” is, for example, information on the order of the multiple history buttons 109. The information on the order is information on the positions of the history buttons 109 from another perspective. In FIG. 15, for convenience, the order of the timeline region 105 is illustrated as “1” to “3” from the top. “History ID” is the same as described in the description of the history table 41.

For example, when displaying the home screen 101, the controller 17 refers to the display table 45 and identifies the history ID corresponding to the history button 109 at each position. The controller 17 refers to the history table 41 and identifies the processing information 51 associated with the identified history ID. The controller 17 then displays at least part of the identified processing information 51 in the corresponding history button 109.

When any one of the history buttons 109 on the home screen 101 is selected, for example, the controller 17 refers to the display table 45 and identifies the history ID corresponding to the selected history button 109. The controller 17 then refers to the history table 41 and identifies the processing information 51 associated with the identified history ID. The controller 17 then displays at least part of the identified processing information 51 in the settings button 131 of the history use screen 121. The results of identifying and reading out the processing information 51 associated with the history ID that was performed when the home screen 101 was displayed may be used here.

When the controller 17 identifies the history ID corresponding to the selected history button 109 as described above, for example, the controller 17 refers to the history table 41 and identifies the image data identification information associated with the identified history ID. The controller 17 then accesses the corresponding image data 31 (and/or 33) based on the identified image data identification information and displays the thumbnail 129. The identification and reading out of the image data identification information associated with the history ID may be performed when the home screen 101 is displayed.

After that, the controller 17 accepts a change to (selection of) the image data to be subjected to new image processing and/or a change (and/or selection) of the processing conditions (setting items). Then, when any one of the use buttons 123 is selected and a prescribed operation is performed on the execute button 125, the controller 17 performs the image processing selected by the use button 123 based on the selected image data.

As described above, the data configuration illustrated in FIG. 15 is for the authenticated user A assuming the display example in FIG. 11. By configuring the same or similar data for other authenticated users and unauthenticated users, a display example the same as or similar to that in FIG. 11 and the display example in FIG. 12 are realized for other authenticated users. However, for unauthenticated users, image data identification information is not necessary, and the image data 31 is not automatically saved. In addition, the display example in FIG. 13 may be realized, for example, by separately creating the history tables 41 for multiple authenticated users and (one) unauthenticated user, while also creating a common display table 45 for multiple authenticated users and an unauthenticated user.

As described in the description of FIG. 8, the image data 31 may be stored in either a volatile memory or a non-volatile memory. In a mode in which the image data 31 is stored in a volatile memory, for example, the history table 41 may also be stored in a volatile memory. In a mode in which the image data 31 is stored in a nonvolatile memory, for example, the history table 41 may also be stored in a nonvolatile memory. From another perspective, the image data 31 and the history information 47 may be deleted at the same time.

The display table 45 may or may not maintain continuity before and after the power is turned on and off (or before and after sleep mode). In the latter case, for example, when the power is turned on (or when the device returns from sleep mode), the controller 17 may generate the display table 45 by referring to the history table 41. As can be understood from this description, the display table 45 may be stored in either a volatile memory or a non-volatile memory, regardless of whether the image data 31 and the history table 41 are stored in a volatile memory or a non-volatile memory.

FIG. 15 is merely an example and is a conceptual diagram. Therefore, the manner in which the various types of information are stored may differ from that described above. For example, in the example in FIG. 15, the history table 41 and the image database 43 are separate from each other, but a database having a specific structure that stores both the history table 41 and the image database 43 may be constructed. In this case, the image data identification information may be no longer required, for example, if the processing information 51 and the image data 31 are stored in contiguous storage areas. In addition, for example, similarly, the history table 41 and the display table 45 may be merged together.

FIG. 16 is a schematic diagram illustrating an example of the contents of the information held in one piece of processing information 51.

The processing information 51 may, for example, hold information on the “type” of image processing, “processing conditions”, “processing date and time”, “user name”, and “communication destination” in association with each other. Note that depending on the type of image processing, there may be irrelevant information (for example, “communication destination” when the “type” is copying). In such a case, for example, no information may be stored in the storage areas corresponding to irrelevant information, or information indicating that the information is irrelevant may be stored in the storage areas. Alternatively, different data structures may be used for the processing information 51 depending on the type of image processing, such that storage areas corresponding to irrelevant information are not reserved.

For example, “image quality” and “layout” information may be stored as “processing conditions” information. These specific pieces of information include, for example, those illustrated in the settings buttons 131 in FIG. 4. For example, “image quality” information may include “color/black & white” and “density” information. “Layout” information may include “paper selection”, “enlarge/reduce”, “page collation”, and “double sided”.

As described with reference to FIG. 15, when the history table 41 is created for each user, each history table 41 only needs to include information of the “user name”, and therefore each piece of processing information 51 does not need to include the “user name”. This shows conceptually how the user name is linked to the processing conditions, etc. However, in reality, the processing information 51 may include information on the user name.

### 8. Example of Procedure of Processing Executed by Image Processing Device

The operation of the image processing device 1 described above may be realized by various procedures. Examples are described below.

FIG. 17 is a flowchart illustrating an example of the procedure of processing performed by the image processing device 1 (controller 17 and authentication management unit 19) for login authentication. Note that whether the functional unit performing each procedure is the controller 17 or the authentication management unit 19 is not necessarily clear.

In the example described with reference to FIGS. 2 to 5, the processing of FIG. 17 is started when the image processing device 1 is powered on (or upon returning from sleep mode). However, unlike in the description here, the processing of FIG. 17 may be started when a prescribed operation is performed on the home screen 101.

In Step ST21, the image processing device 1 displays a screen (or window) for authentication on the operation panel 9. An example of the screen (not illustrated) displayed at this time is as illustrated in FIG. 2.

In Step ST22, the image processing device 1 judges whether or not an ID and a password have been entered. If the judgment is positive, the image processing device 1 proceeds to Step ST23, and if the judgment is negative, the image processing device 1 proceeds to Step ST27.

In Steps ST23 and T24, the image processing device 1 checks the input ID and password against the authentication table 55 in order to confirm their validity. If the authentication is successful, the image processing device 1 proceeds to Step ST25, and if the authentication is unsuccessful, the image processing device 1 returns to Step ST21. At this time, as already described, a message indicating that the authentication has failed may be displayed.

In Step ST27, the image processing device 1 judges whether or not the “guest user” button shown on the login screen 151 in FIG. 2 has been operated. If the judgment is positive, the image processing device 1 proceeds to Step ST26, and if the judgment is negative, the image processing device 1 returns to Step ST21.

In Step ST25, the image processing device 1 sets various settings so that operations are performed according to an authenticated user as described previously. From another perspective, the image processing device 1 grants the user authorization for image processing. On the other hand, in Step ST26, various settings are set so that operations are performed according to an unauthenticated user described above.

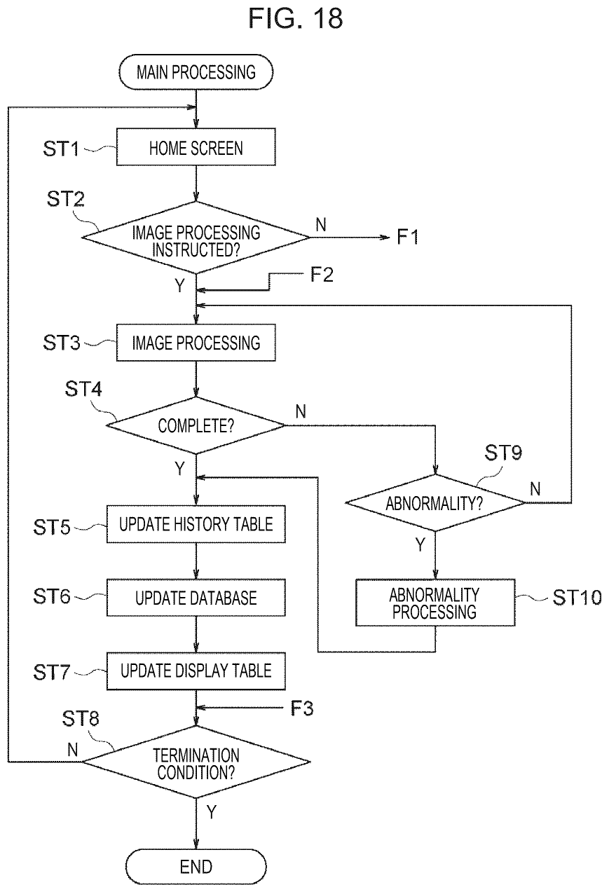

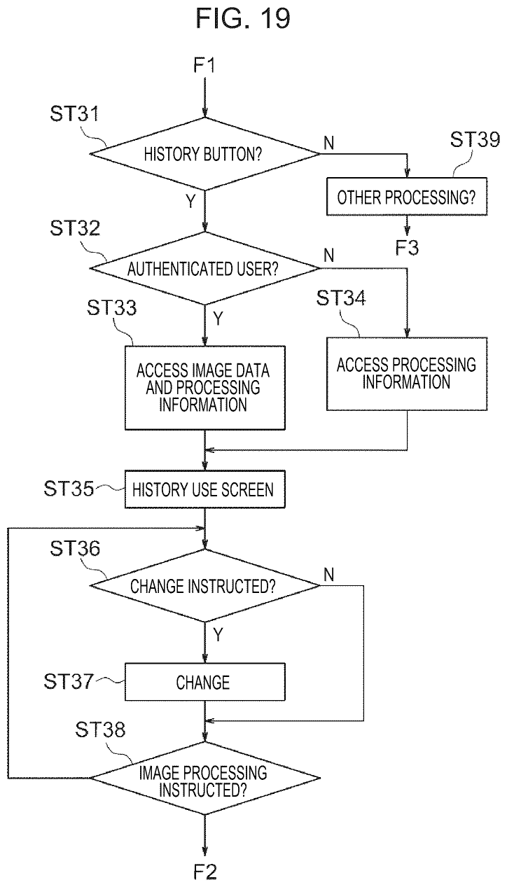

FIGS. 18 and 19 are flowcharts illustrating examples of procedures of processing executed by the controller 17 in order to realize operations related to the use of the history buttons 109.

This processing is started, for example, once the login authentication processing described with reference to FIG. 17 is completed. However, as already mentioned, the login authentication may be performed after the home screen 101 has launched, and furthermore, the processing of FIG. 18 and FIG. 19 may be started when the power supply of the image processing device 1 is turned on (or upon returning from sleep mode).

In FIG. 18, generally speaking, an example of the processing procedure for when image processing is performed in response to an operation performed on any of the function buttons 107 on the home screen 101 is illustrated. FIG. 19 illustrates, generally speaking, an example of the processing procedure for when image processing is performed in response to an operation performed on any of the history buttons 109.

In Step ST1 (FIG. 18), the controller 17 displays the home screen 101 on the operation panel 9. The timeline region 105 displayed at this time may be for each authenticated user or for unauthenticated users, as described with reference to FIG. 11 and FIG. 12. Alternatively, the timeline region 105 may be for all users, as described with reference to FIG. 13. In the description here, the former case (FIG. 11 and FIG. 12) may be taken as an example without being specifically mentioned.

In Step ST2, the controller 17 judges whether or not execution of image processing has been instructed. For example, as previously mentioned, an instruction for executing image processing is given by tapping any of the function buttons 107 and then tapping the execute button displayed on the screen (or window) that is displayed afterwards. The controller 17 then proceeds to Step ST3 in the case of a positive judgement, and to Step ST11 in FIG. 19 via a symbol F1 illustrated in FIG. 18 and FIG. 19 in the case of a negative judgement.

In Step ST3, the controller 17 starts the image processing instructed to be performed.

In Step ST4, the controller 17 judges whether or not the image processing instructed to be performed has been completed. If the judgment is positive, the controller 17 proceeds to Step ST5, and if the judgment is negative, the controller 17 proceeds to Step ST9.

In Step ST5, the controller 17 updates the history table 41 illustrated in FIG. 15. For example, new history information 47 is generated based on the information of the current image processing, and the generated history information 47 is added to the history table 41. If the number of pieces of history information 47 has reached the upper limit (for example, the same value as the upper limit of history buttons 109 that can be displayed), the piece of history information 47 having the oldest processing date and time is deleted. The processing date and time included in the history information 47 may be that at an appropriate time such as at the time of a positive judgement in Step ST2, at the time of a positive judgement in Step ST4, or at the time when the history table 41 is updated in Step ST5.

In Step ST6, the controller 17, for example, updates the image database 43 illustrated in FIG. 15. For example, the image data 31 for the current image processing is added to the image database 43. When history information 47 is to be deleted as described above, the image data 31 corresponding to the history information 47 to be deleted is also deleted.

In Step ST7, the controller 17 updates the display table 45 illustrated in FIG. 15. For example, the correspondence between the order and the history ID is changed so that the order associated with the history ID is moved down by one. If the number of history IDs has reached the upper limit (corresponding to the upper limit of history buttons 109 that can be displayed) prior to moving down, the history ID with the bottommost order is deleted. The history ID for the current image processing (the history ID assigned to the history information 47 generated in Step ST5) is then associated with the uppermost order.

FIG. 18 is conceptual diagram for facilitating understanding. Therefore, for example, in reality, Steps ST5 to ST7 may be performed in a procedure that cannot be divided as described above. In addition, the order of Steps ST5 to ST7 may be different from that described above.

In Step ST8, the controller 17 judges whether or not a termination condition has been satisfied. The termination condition may be, for example, the occurrence of a prescribed trigger (as described above) for performing a logout process. If the judgement is negative, the controller 17 returns to Step ST1, and if the judgement is positive, the controller 17 terminates the main processing of FIG. 18 and performs the processing for authentication of FIG. 17 again.

In Step ST9, the controller 17 judges whether or not any abnormalities have occurred with respect to the image processing instructed to be performed. If the judgement is negative, the controller 17 returns to Step ST3 and continues the image processing. On the other hand, if the judgement is positive, the controller 17 proceeds to Step ST10.

There are different types of abnormalities in different types of image processing. For example, there are paper jams in copying or printing, document jams in copying, scanning, faxing, or emailing, and communication errors in faxing or emailing.

In Step ST10, processing is performed in accordance with the abnormality. In this case, the content of the processing and the Steps to be followed after the processing may be set as appropriate in accordance with the type of abnormality.

For example, if the abnormality is a paper or document jam, the controller 17 displays an image on the operation panel 9 instructing the user to clear the jam. Once the abnormality has been resolved, the controller 17 returns to Step ST3 (this path is not illustrated in FIG. 18).

In addition to (or instead of) displaying an instruction to clear the abnormality as described above, the controller 17 may accept cancellation (or suspension; this also applies below) of image processing via the operation panel 9. If the image processing is cancelled, the controller 17 skips Steps ST5 to ST7 and proceeds to Step ST8 or ST1 (this path is not illustrated in FIG. 18).

In the case of cancellation as described above, depending on the type of abnormality, data related to image processing (image data 31) may have been acquired at the stage of Step ST10. For example, if the abnormality is a paper jam in copying or printing, the data of the image to be printed is stored in the storage unit 13 (for example, RAM). In this case, unlike in the above description, the controller 17 may proceed to Step ST5 (illustrated example).

For example, if the abnormality is a communication error in faxing or emailing, the controller 17 displays on the operation panel 9 that abnormality termination will be carried out because a communication error has occurred. In this case, the controller 17 may proceed to Step ST5 (illustrated example) or skip Steps ST5 to ST7 and proceed to Step ST8 or ST1.

In Step ST31 (FIG. 19), controller 17 judges whether or not a prescribed operation has been performed on a history button 109 on the home screen 101. If the judgement is positive, the controller 17 proceeds to Step ST32, and if the judgement is negative, the controller 17 proceeds to Step ST39.

In Step ST32, the controller 17 judges whether or not the current user is an authenticated user. If the judgement is positive, the controller 17 proceeds to Step ST33, and if the judgement is negative, the controller 17 proceeds to Step ST34.

In Step ST33, the controller 17 accesses the image data 31 and processing information 51 corresponding to the history button 109 operated in Step ST31. In addition, in Step ST34, the controller 17 accesses the processing information 51 corresponding to the history button 109 operated in Step ST31.

In Step ST35, if the processing has passed through Step ST33, the controller 17 displays the history use screen 121 (FIG. 4) based on the image data 31 and processing information 51 accessed in Step ST33. In addition, if the processing has passed through Step ST34, the controller 17 displays the history use screen 121A (FIG. 5) based on the processing information 51 accessed in Step ST34.

Note that, although not specifically illustrated, in the case of the display example in FIG. 13, in addition to the illustrated processing, for example, a judgement as to whether or not the current user is a user associated with the touched history button 109 may be performed.

In Step ST36, the controller 17 judges whether or not a change to the image data and/or the processing conditions to be used in the new image processing has been instructed via the operation panel 9. Note that, when the history use screen 121A is displayed, this procedure is a judgement as to whether or not image data has been selected. Then, if the judgement is positive, the controller 17 proceeds to Step ST37, and if the judgement is negative, the controller 17 skips Step ST37 and proceeds to Step ST38.

In Step ST37, the controller 17 changes (selects) the image data and/or processing conditions to be used for the new image processing based on the instruction in Step ST36.

In Step ST38, the controller 17 judges whether or not execution of image processing has been instructed. The instruction to execute image processing is made, for example, by tapping the execute button 125 with any one of the use buttons 123 selected, as previously described. Then, when the judgement is positive, the controller 17 proceeds to Step ST3 in FIG. 18 via a symbol F2 illustrated in each of FIG. 18 and FIG. 19, and when the judgement is negative, the controller 17 returns to Step ST36.

Note that, although not specifically illustrated, when the execute button 125 is tapped while the history use screen 121A is displayed (in other words, when no image data is selected), for example, an error message may be displayed and the processing may return to Step ST36.

In Step ST39, the controller 17 performs other processing (or does not perform any substantial processing). Examples of the other processing may include processing for connecting the image processing device 1 to another device via a VPN (virtual private network). After that, the controller 17 proceeds to Step ST8 in FIG. 18 via a symbol F3 illustrated in each of FIG. 18 and FIG. 19.

### 9. Summary of Embodiments

As described above, the image processing device 1 may include the operation panel 9, the storage unit 13, and the controller 17. The operation panel 9 may receive instructions from a user regarding image processing, and may be capable of displaying multiple history buttons 109 including information on past image processing. The storage unit 13 may be capable of storing the image data 31 and/or 33, and may also be capable of storing the processing information 51 indicating the processing mode of the image processing displayed on the history buttons 109. The controller 17 may allow an authenticated user to access a specific type of image data and processing information 51 via the history buttons 109 based on the result of login authentication. The controller 17 may also deny an unauthenticated user access to the specific type of image data via the history buttons 109 based on the result of the login authentication, while allowing the unauthenticated user to access processing information via the history buttons.

Consequently, for example, as described in the description of the overview of the embodiment, the processing information 51 (processing conditions) can be used not only by the authenticated user but also by an unauthenticated user, improving the convenience for unauthenticated user. On the other hand, by denying the unauthenticated user access to the specific type of image data, security can be improved.

The operation panel may display multiple function buttons 107 for accepting different types of image processing and multiple history buttons 109 on the same screen (home screen 101).

In this case, compared to, for example, a mode in which multiple history buttons 109 are displayed in response to an operation performed on the home screen 101 (this mode may also be included in the technology according to the present disclosure), since there is no need to switch screens from the home screen 101, access to information related to past image processing is simplified and/or accelerated. As a result, user convenience is improved.

When an authenticated user is logged in, the operation panel 9 may display the history buttons 109 including information on past image processing performed by the currently logged-in authenticated user, while not displaying the history buttons 109 including information on past image processing performed by other authenticated users (FIGS. 3 and 11).

In this case, for example, the likelihood that the history buttons 109 of the logged-in authenticated user becoming buried under the history buttons 109 of other users and being difficult to locate is reduced, thereby improving convenience for the authenticated user.

When an authenticated user is not logged in, the operation panel 9 may display the history buttons including information on past image processing performed by the current unauthenticated user and other unauthenticated users.

In this case, for example, since there is no need to distinguish between multiple persons (or groups) as unauthenticated users, the burden on the image processing device 1 is reduced. Note that a mode in which unauthenticated users are distinguished between may also be included in the technology according to the present disclosure.

The specific type of image data may be data handled in past image processing, the information of which is displayed on the multiple history buttons 109.

In this case, for example, an authenticated user can easily use the image data 31 handled in the past for new image processing. For example, after performing copying, the same image can be reprinted without needing to scan the document again. As a result, the convenience is improved for the authenticated user. On the other hand, security is improved by denying access to the image data 31 by unauthenticated users. Note that the history buttons 109 can contain information about image processing that has been “completed” in the past and allow access to the image data 31 that corresponds to that information. In known image processing devices, image data that has been temporarily stored in RAM for the purpose of performing image processing cannot be accessed because the image data is deleted once the image processing is completed.

The specific type of image data may be data (image data 31) saved when performing image processing corresponding to any of the types of copying, scanning, and printing.

In this case, for example, the history buttons 109 can be used for functions that are frequently used in a multifunction machine. In other words, convenience is improved for an authenticated user.

The specific type of image data may be data (image data 33) saved in a box in data saving processing. From another perspective, the specific type of image data may be different from the data (image data 31) that was automatically saved during past image processing, the information of which is displayed on the multiple history buttons 109.

In this case, for example, the processing conditions of the past image processing can be applied to new image processing for image data 33 that is unrelated to the past image processing. As a result, for example, a user will be easily able to apply the same processing conditions to multiple pieces of image data, or perform image processing based on new image data 33 when a mix-up in image data is noticed after performing image processing.

When an authenticated user is logged in, the specific type of image data may be data associated with the currently logged-in authenticated user and stored in a box (e.g., image data 33 stored in the user box BXU). From another perspective, when an authenticated user is logged in, the box in which the specific type of image data is stored may be accessible to the currently logged-in authenticated user, and may be inaccessible by other authenticated users and unauthenticated users. From the opposite perspective, when an authenticated user is not logged in (when an unauthenticated user is using the image processing device 1), the specific type of image data may be data associated with all authenticated users (registered users) and stored in a box or may be data in a user box to which access is permitted for each authenticated user.

In this case, for example, security is improved for authenticated users because the image data 33 associated with the authenticated users cannot be used by unauthenticated users. From the opposite perspective, unauthenticated users can use the image data 33 not associated with authenticated users, and convenience for unauthenticated users is improved. Data stored in a box and associated with an authenticated user may include image data 33 stored in a non-shared box associated with the authenticated user, as well as image data 33 stored in a shared box but associated with the authenticated user (e.g., image data 33 including information on the authenticated user as the creator of the image data 33).

The processing information 51 may include at least one selected from a group consisting of type of image processing, processing conditions, and communication destination.

In this case, for example, at least one of the above can be used for new image processing, and as a result convenience is improved for authenticated users and unauthenticated users. The processing conditions and communication destination may be troublesome to input. Furthermore, even a slight input error in the communication destination may result in the leakage of highly confidential information. By reusing such items, convenience is improved.

The processing conditions may include at least one of image quality or page layout.

In this case, for example, when printing based on the same image data is repeatedly performed while changing the image quality and page layout in order to find suitable processing conditions, the printing history is easily checked. As a result, selecting the history button 109 considered the best choice at a later time and performing printing again under those processing conditions is facilitated.

Denial of access to a specific type of image data may include denial of displaying a list of data in a folder in which the specific type of image data is saved, denial of selection of data in the folder, or denial of image processing on all data in the folder or the specific type of image data.

Denial of various types of access in this manner can improve security, for example. For example, denial of displaying a list of data in a folder can conceal the existence of the data itself, thereby improving security.

The controller 17 may permit an authenticated user to use the specific type of image data for new image processing via the history buttons 109.

In this case, for example, as described above, image processing based on image data handled in the past can be easily performed via the history buttons 109. From another perspective, the operations that can be performed by selecting the history buttons 109 can be broadened, compared to a mode in which only the processing information 51 is available via the history buttons 109.

The processing information 51 may include information indicating the type of image processing. The controller 17 may permit an authenticated user to use, via a history button 109, a specific type of image data for a type of image processing different from the type of image processing indicated by the processing information 51 corresponding to the operated history button 109.

In this case, for example, the history buttons 109 can be used to easily execute various types of image processing on the same image, and user convenience is improved. In addition, for example, redundant operations can be omitted to reduce the burden on the user and/or the image processing device 1. More precisely, for example, after “copying” has been performed using the relevant function button 107, “printing”, “sending by fax”, “sending by email” and/or “saving to box” (or scanning, from another perspective) can be performed using the use buttons 123 without having to reset the document. Furthermore, the processing conditions of the original image processing can sometimes be applied to the new image processing (for example, “copying” and “printing” are at least partially compatible in terms of processing conditions). This also improves convenience.

The processing information 51 may include information indicating the type of image processing and the processing conditions. The controller 17 may permit an authenticated user to use a specific type of image data for image processing of the same type as the type of image processing indicated by the processing information 51 corresponding to the operated history button 109, but with processing conditions different from those indicated by the corresponding processing information 51.

The term “same type” used here may mean, for example, the same combination with or without various operations such as scanning, printing, sending faxes, receiving faxes, sending emails, receiving emails, and so on. For example, “copying” and “printing” differ from each other because only the former includes “scanning”. The “print” function button 107 is for performing printing based on image data stored in a storage medium, which is not illustrated, connected to the image processing device 1, whereas the “print” use button 123 is for performing printing based on the image data 31 stored in the storage unit 13. Although the image data is stored in different devices in these operations, only printing is performed in both operations and therefore the operations may be considered to be the same type of image processing. Printing based on image data selected via the “box” function button 107 may also be considered to be the same type of image processing as the “print” function button 107 and the “print” use button 123.

When the same type of image processing is performed with different processing conditions as described above, the image processing can be easily repeated, for example, when a mistake is made regarding the setting of processing conditions, or when the results of the executed image processing are not what was expected. For example, if “color” printing was intended to be performed but the default setting was “black & white”, printing can be conveniently carried out again. In addition, for example, if the density and/or size of a printed image is not what was expected, the image can be easily re-printed with a different density and/or size.

The controller 17 may permit an authenticated user to use a specific type of image data and other types of image data for image processing in a processing mode at least partially the same as the processing mode indicated by the processing information 51 corresponding to the operated history button 109. In addition, the controller 17 may permit an unauthenticated user to use the other types of image data (e.g., image data 33 in a shared box) for image processing in a processing mode at least partially the same as the processing mode indicated by the processing information corresponding to the operated history button.

In this case, convenience is improved compared to, for example, a mode in which the permission of access to the image data and/or processing information 51 indicates that only viewing is permitted (this mode may also be included in the technology according to the present disclosure).

The technology according to the present disclosure is not limited to the above embodiments and may be implemented in the form of various modes.

For example, part or all of a processing mode corresponding to a history button (e.g., the type of image processing and the processing conditions) may be registered as one of processing mode templates by operating the execute button 125 in a screen similar to the history use screen 121 but not including the use buttons 123. In other words, image processing via the history buttons need not be performed.

Inventions may be extracted from various viewpoints from the present disclosure. In this case, features described in the description of the embodiments may not be required. For example, an invention having a feature that automatically saved image data is accessed via the history buttons may be extracted from the present disclosure. In this case, for example, authentication may not be required, access to image data in a box via the history buttons may not be possible, and access to processing information may not be possible.

1. An image processing device comprising:
an operation panel configured to accept an instruction from a user regarding image processing and be capable of displaying multiple history buttons containing information on past image processing;
a storage unit configured to be capable of storing image data and processing information indicating processing modes of image processing displayed on the history buttons; and
a controller configured to, based on a result of login authentication, allow an authenticated user to access a specific type of image data and the processing information via the history buttons, and deny an unauthenticated user access to the specific type of image data via the history buttons while allowing the unauthenticated user to access the processing information via the history buttons.

2. The image processing device according to claim 1,
wherein the operation panel displays multiple function buttons for accepting different types of image processing and the multiple history buttons on an identical screen.

3. The image processing device according to claim 1,
wherein when an authenticated user is logged in, the operation panel displays a history button that contains information on past image processing performed by the authenticated user who is currently logged in and does not display a history button that contains information on past image processing performed by another authenticated user.

4. The image processing device according to claim 1,
wherein the operation panel displays history buttons containing information on past image processing performed by a current unauthenticated user and other unauthenticated users when an authenticated user is not logged in.

5. The image processing device according to claim 1, p1 wherein the specific type of image data is data handled in past image processing whose information is displayed by the multiple history buttons.

6. The image processing device according to claim 5,
wherein the specific type of image data is data saved when image processing corresponding to any one of types of copying, scanning, and printing is performed.

71 The image processing device according to claim 1,
wherein the specific type of image data is data saved in a box by data saving processing.

8. The image processing device according to claim 7,
wherein when an authenticated user is logged in, the specific type of image data is data associated with the authenticated user who is currently logged in and saved in the box.

9. The image processing device according to claim 7,
wherein when an authenticated user is logged in, the authenticated user who is currently logged in is allowed to access the box, and other authenticated users and unauthenticated users are denied access to the box.

10. The image processing device according to claim 7,
wherein the specific type of image data is different from data automatically saved during past image processing whose information is displayed on the multiple history buttons.

11. The image processing device according to claim 1,
wherein the processing information includes at least one piece of information selected from a group consisting of type of image processing, processing condition, and communication destination.

12. The image processing device according to claim 11,
wherein the processing condition includes at least one of image quality or page layout.

13. The image processing device according to claim 1,
wherein denial of access to the specific type of image data includes denial of displaying a list of data in a folder in which the specific type of image data is saved, denial of selection of data in the folder, or denial of image processing on all data in the folder or the specific type of image data.

14. The image processing device according to claim 1,
wherein the controller allows an authenticated user to use the specific type of image data for new image processing via a history button.

15. The image processing device according to claim 14,
wherein the processing information includes information indicating a type of image processing, and
the controller allows an authenticated user to use, via a history button, the specific type of image data for a type of image processing different from a type of image processing indicated by processing information corresponding to an operated history button.

16. The image processing device according to claim 14,
wherein the processing information includes information indicating a type of image processing and a processing condition, and
the controller allows an authenticated user to use the specific type of image data for image processing of an identical type as a type of image processing indicated by processing information corresponding to an operated history button, but with a processing condition different from a processing condition indicated by the corresponding processing information.

17. The image processing device according to claim 1,
wherein the controller allows an authenticated user to use the specific type of image data and another type of image data for image processing in a processing mode at least partially identical to a processing mode indicated by processing information corresponding to an operated history button, and
allows an unauthenticated user to use the other type of image data for image processing in a processing mode at least partially identical to a processing mode indicated by processing information corresponding to an operated history button.
